(19) United States
(12) Patent Application Publication
(10) Pub. No.: US 2016/0053161 A1
(43) Pub. Date: Feb. 25, 2016

(54) RESIN COMPOSITION, INJECTION MATERIAL AND PACKING METHOD

(71) Applicant: SUMITOMO BAKELITE COMPANY LIMITED, Tokyo (JP)

(72) Inventors: Fumihiro Maeda, Tokyo (JP); Yasushi Arita, Tokyo (JP); Masakatsu Asami, Tokyo (JP)

(73) Assignee: SUMITOMO BAKELITE COMPANY LIMITED, Tokyo (JP)

(21) Appl. No.: 14/784,639

(22) PCT Filed: Mar. 28, 2014
(86) PCT No.: PCT/JP2014/059218

§ 371 Date: Oct. 15, 2015

(30) Foreign Application Priority Data
Apr. 16, 2013 (JP) 2013-086118

(51) Int. Cl. C09K 8/68; C08G 8/10; E21B 43/267; C08G 16/02

(52) U.S. Cl. CPC C09K 8/68; C08G 16/0262; C08G 8/10; E21B 43/267

(57) ABSTRACT

The injection material 100 contains particles 2 adapted to be packed into the fracture, a resin composition and a fluid 20 for transferring the particles 2 and the resin composition into the fracture. Further, the resin composition is used for forming a surface layer covering at least a part of an outer layer of each of the particles 2. The resin composition contains an acid-curing agent and an acid-curing resin which can cure in the presence of an acid. The acid-curing agent has an acid group which is present in a state that the acid group is blocked by a compound having reactivity with respect to the acid group. The resin composition can reliably cure the acid-curing resin at a target location, the injection material containing the resin composition and the particles and a packing method for packing the particles into the fracture formed in the subterranean formation.

### TECHNICAL FIELD

The present invention relates to a resin composition, an injection material and a packing method.

### BACKGROUND ART

Recently, recovery of oily hydrocarbon or gaseous hydrocarbon (fluid) from a subterranean formation is positively carried out. Specifically, a wellbore is formed so as to penetrate a subterranean formation (shale formation) containing hydrocarbon. The hydrocarbon contained in the subterranean formation can be recovered through the wellbore. In this case, the subterranean formation is required to have sufficient conductivity (fluid permeability) to allow the fluid to flow through the wellbore.

In order to ensure the conductivity of the subterranean formation, for example, hydraulic fracturing is carried out. In the hydraulic fracturing operations, a viscous liquid is first injected into the subterranean formation through the wellbore at a sufficient rate and pressure to form fractures (cracks) in the subterranean formation. After that, an injection material containing particles is injected into the subterranean formation to pack the particles into the formed fractures for the purpose of preventing the fractures from being closed (blocked).

As such particles, for example, it is possible to use coated particles obtained by coating core particles such as silica sand or glass beads with a thermosetting resin such as an epoxy resin and a phenol resin. However, for producing such coated particles, there is a problem that a large amount of energy is required for curing the thermosetting resin.

For this reason, an injection material into which particles, an epoxy resin and an acid-curing agent are added has been suggested for solving the above problem (for example, see patent document 1). The injection material is used for packing the particles, the epoxy resin and an amine curing agent into the fractures formed in the subterranean formation and then curing the epoxy resin due to an action of the amine curing agent by utilizing subterranean heat energy to coat the particles with a cured material of the epoxy resin and fix the coated particles in the fractures.

However, in such an injection material, the epoxy resin and the acid-curing agent always make contact with each other. Thus, there is a possibility that the epoxy resin is cured at an undesired location differing from a target location, that is, under undesired conditions of a curing start time and a curing start temperature differing from target conditions. For example, if the epoxy resin is cured in the middle of the wellbore or the curing of the epoxy resin does not start after the injection material reaches to the fractures, it becomes difficult to sufficiently pack the particles into the fractures. As a result, there is a case where the recovery of the hydrocarbon becomes difficult.

Further, for the purpose of fixing (reinforcing) a bottom part of the wellbore in the subterranean formation with silica particles other than the purpose of preventing the fractures formed in the subterranean formation from being closed (blocked), for example, patent document 2 discloses the following method. Namely, the method for fixing (reinforcing) the bottom part of the wellbore by utilizing a binding of the silica particles has been suggested. In the method, a resin composition containing a furan resin and a block acid serving as the acid-curing agent is used for desorbing a blocking compound from the block acid (acid-curing agent) at the bottom part of the wellbore to bind the silica particles with each other due to the curing of the furan resin caused by an action of the acid-curing agent from which the blocking compound is desorbed. Due to the binding of the silica particles, the bottom part of the wellbore is fixed (reinforced).

However, even in the case of using the aforementioned method, if the blocking compound does not desorb from the block acid at the bottom part of the wellbore where the blocking compound should desorb, there is a problem that the furan resin is cured at an undesired location, that is, under undesired conditions of a curing start time and a curing start temperature.

### RELATED ARTS

### Patent Documents

Patent document 1: U.S. Pat. No. 5,609,207

Patent document 2: U.S. Pat. No. 7,347,264

### SUMMARY OF THE INVENTION

### Problem to be Solved by the Invention

It is an object of the present invention to provide a resin composition which can reliably cure an acid-curing resin at a target location, an injection material containing such a resin composition and particles and an packing method for packing such particles into a fracture formed in a ground.

### Means for Solving Problem

In order to achieve the object, the present invention includes the following features (1) to (17).

(1) A resin composition used for forming a surface layer covering at least a part of an outer surface of a particle, the particle adapted to be packed into a fracture formed in a subterranean formation, the resin composition comprising:

an acid-curing agent; and

an acid-curing resin which can cure in the presence of an acid,

wherein the acid-curing agent has an acid group which is present in a state that the acid group is blocked by a compound having a reactivity with respect to the acid group, and

wherein a property of the resin composition is set so that the acid-curing resin starts to cure at a temperature in the range of 50 to 110° C. and within time in the range of 2 to 8 hours by adjusting a kind and a contained amount of each of the acid-curing resin, the acid-curing agent and the compound.

(2) The resin composition according to the above (1), wherein the property of the resin composition is set so that the acid-curing resin completes curing thereof within 48 hours.

(3) The resin composition according to the above (1) or (2), wherein the compound has a functional group, and

wherein the functional group chemically bonds with the acid group of the acid-curing agent to block the acid-curing agent.

(4) The resin composition according to the above (3), wherein the functional group contains at least one selected from the group consisting of a hydroxyl group and an amino group.

(5) The resin composition according to the above (3) or (4), wherein the compound is an alkyl alcohol having a hydroxyl group as the functional group.

(6) The resin composition according to the above (5), wherein the alkyl alcohol is a monohydric alkyl alcohol.

(7) The resin composition according to the above (6), wherein a carbon number of the monohydric alkyl alcohol is in the range of 1 to 10.

(8) The resin composition according to the above (3) or (4), wherein the compound is an alkyl amine having an amino group as the functional group.

(9) The resin composition according to any one of the above (3) to (8), wherein when the number of the acid groups is defined as “1”, the compound contains the functional groups so that the number of the functional groups satisfies a relationship of the number of the acid groups:the number of the functional groups=1:0.1 to 1:1.9.

(10) The resin composition according to any one of the above (1) to (9), wherein the acid group contains a sulfonic acid group.

(11) The resin composition according to the above (10), wherein the acid-curing agent contains at least one selected from the group consisting of a p-toluenesulfonic acid, a benzenesulfonic acid, a dodecylbenzenesulfonic acid, a phenolsulfonic acid, a naphthalene sulfonic acid, a dinonylnaphthalene sulfonic acid and a dinonylnaphthalene disulfonic acid.

(12) The resin composition according to any one of the above (1) to (11), wherein the contained amount of the acid-curing agent is in the range of 0.25 to 20 parts by weight with respect to 100 parts by weight of the acid-curing resin.

(13) The resin composition according to any one of the above (1) to (12), wherein the acid-curing resin contains at least one selected from the group consisting of a furan resin and a phenol resin.

(14) A resin composition used for forming a surface layer covering at least a part of an outer surface of a particle, the particle adapted to be packed into a fracture formed in a subterranean formation, the resin composition comprising:

a furan resin serving as an acid-curing agent; and

a para-toluenesulfonic acid serving as an acid-curing resin which can cure in the presence of an acid,

wherein the para-toluenesulfonic acid has a sulfonic acid group which is present in a state that the sulfonic acid group is blocked by a monohydric alkyl alcohol having a carbon number in the range of 1 to 6 and serving as a compound having a reactivity with respect to the sulfonic acid group, and

wherein a property of the resin composition is set so that the furan resin starts to cure at a temperature in the range of 70 to 90° C. and within time in the range of 4 to 6 hours by adjusting a contained amount of the para-toluenesulfonic acid, which is blocked by the monohydric alkyl alcohol, with respect to 100 parts by weight of the furan resin to fall within the range of 0.25 to 20 parts by weight.

(15) An injection material adapted to be injected into a fracture formed in a subterranean formation, the injection material comprising:

particles to be packed into the fracture;

the resin composition defined by any one of the above (1) to (14); and

a fluid for transferring the particles and the resin composition into the fracture.

(16) The injection material according to the above (15), wherein an average particle size of the particles is in the range of 100 to 3,000 μm.

(17) The injection material according to the above (15) or (16), wherein a contained amount of the particles is in the range of 5 to 50 wt %.

(18) The injection material according to any one of the above (15) to (17), wherein a contained amount of the resin composition is in the range of 1 to 20 parts by weight with respect to 100 parts by weight of the particles.

(19) A packing method for packing particles into a fracture formed into a subterranean formation by transferring the injection material defined by any one of the above (15) to (18) into the fracture formed in the subterranean formation through a wellbore penetrating the subterranean formation to inject the injection material into the fracture, the packing method comprising:

reacting an acid-curing agent with an acid-curing resin by allowing a compound to leave from the acid-curing agent by using a subterranean temperature and/or pressure at the time of injecting the injection material into the fracture to cure the acid-curing resin due to an action of the acid-curing agent and cover at least a part of an outer surface of each of the particles with a cured material of the acid-curing resin.

### Effects of the Invention

According to the present invention, it is possible to prevent the acid-curing resin from curing at an undesired location because the acid group contained in the acid-curing agent among the acid-curing agent and the acid-curing agent is present in a state that the acid group is blocked by the compound having the reactivity with respect to the acid group and leaving of the compound is designed so that the acid-curing resin starts to cure at the temperature in the range of 50 to 110° C. and within the time in the range of 2 to 8 hours.

### BRIEF DESCRIPTION OF THE DRAWINGS

FIG. 1 is a view showing an embodiment of an injection material according to the present invention.

FIG. 2 is a partial cross-sectional view showing coated particles obtained by coating particles with a cured material of an acid-curing resin.

FIG. 3 is a partial cross-sectional view showing a state that pressure is added to the coated particles shown in FIG. 2.

FIG. 4 is a conceptual view for explaining a method for recovering hydrocarbon from a subterranean formation.

FIG. 5 is a graph showing a relationship between a curing situation (degree) and a curing time of a resin composition of each example and comparative example 2B.

FIG. 6 is another graph showing the relationship between the curing situation and the curing time of the resin composition of each example.

FIG. 7 is another graph showing the relationship between the curing situation and the curing time of the resin composition of each example and each comparative example.

FIG. 8 is another graph showing the relationship between the curing situation and the curing time of the resin composition of each example.

FIG. 9 is another graph showing the relationship between the curing situation and the curing time of the resin composition of each example.

FIG. 10 is another graph showing the relationship between the curing situation and the curing time of the resin composition of each example.

FIG. 11 is another graph showing the relationship between the curing situation and the curing time of the resin composition of each example.

FIG. 12 is another graph showing the relationship between the curing situation and the curing time of the resin composition of each example.

FIG. 13 is another graph showing the relationship between the curing situation and the curing time of the resin composition of each example.

FIG. 14 is another graph showing the relationship between the curing situation and the curing time of the resin composition of each example.

FIG. 15 is another graph showing the relationship between the curing situation and the curing time of the resin composition of each example.

FIG. 16 is a graph showing a compressive strength of a cured material obtained from an injection material of each example and each comparative example.

FIG. 17 is another graph showing the compressive strength of the cured material obtained from the injection material of each example and comparative example 1P.

### DESCRIPTION OF THE PREFERRED EMBODIMENTS

Hereinafter, a resin composition, an injection material and a packing method according to the present invention will be described in detail with reference to preferred embodiments shown in the accompanying drawings.

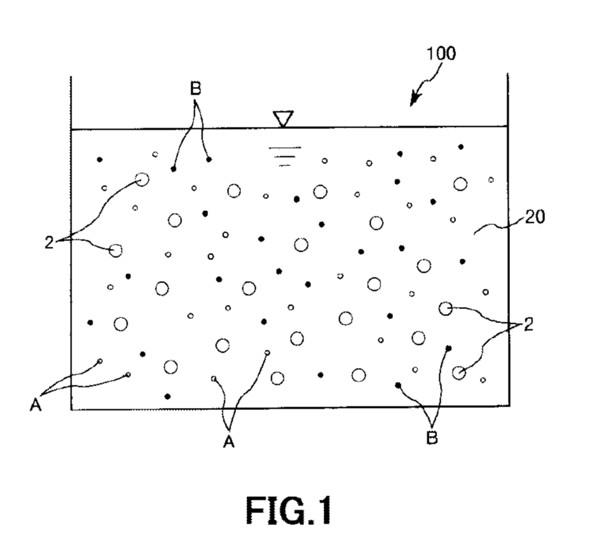

FIG. 1 is a view showing an embodiment of the injection material according to the present invention.

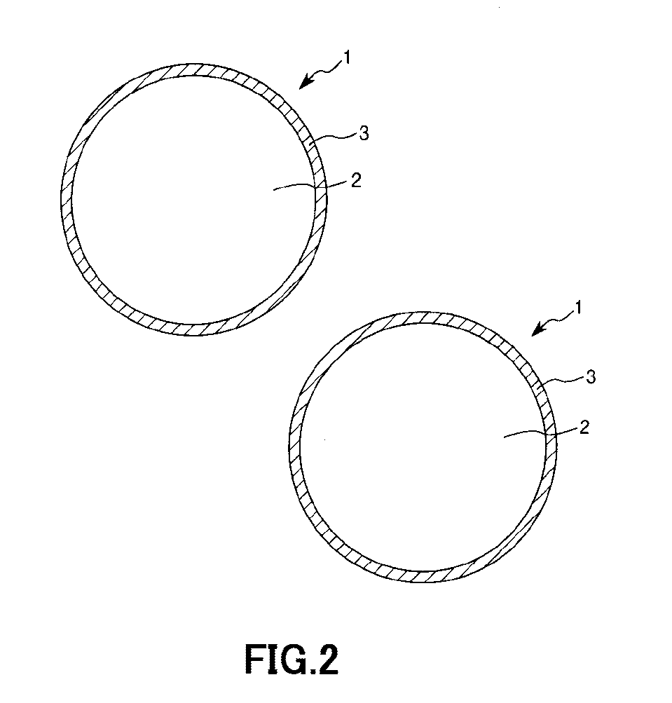

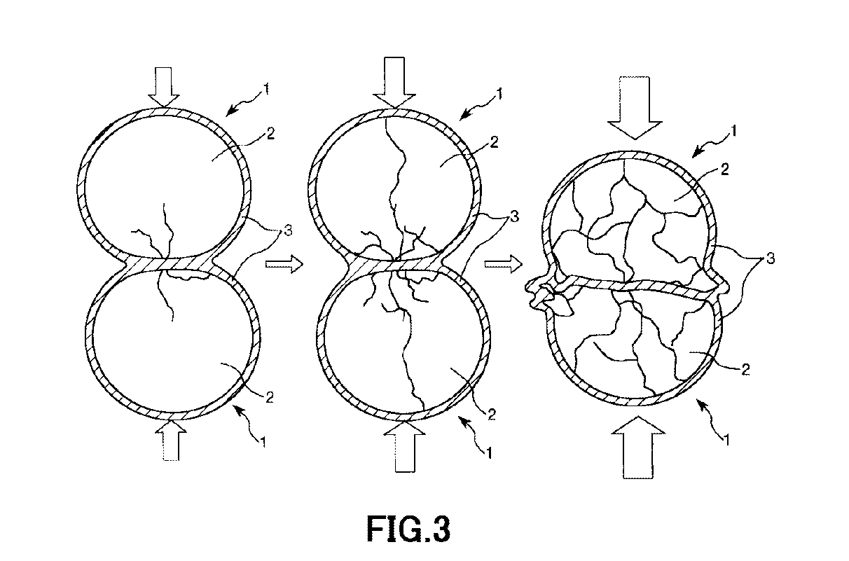

FIG. 2 is a partial cross-sectional view showing coated particles obtained by coating particles with a cured material of an acid-curing resin. FIG. 3 is a partial cross-sectional view showing a state that pressure is added to the coated particles shown in FIG. 2.

The injection material according to the present invention is injected into a fracture(s) formed in a subterranean formation at the time of recovering oily or gaseous hydrocarbon (fluid) from the subterranean formation (shale formation). As shown in FIG. 1, an injection material 100 of this embodiment contains particles 2 adapted to be packed in the fracture, an acid-curing agent A whose acid group is blocked, an acid-curing resin B which can cure due to an action of the acid-curing agent A and a fluid 20 for transferring the particles 2, the acid-curing agent A and the acid-curing resin B into the fracture. In this regard, a resin composition of the present invention is composed of the acid-curing agent A whose acid group is blocked and the acid-curing resin B.

Each of the particles 2 is coated (covered) with an surface layer 3 formed from a cured material of the acid-curing resin B as shown in FIG. 2 in a state that the particles 2 are packed in the fracture formed in the subterranean formation. Each particle 2 is present as a coated particle 1. The coated particles 1 are packed in the fracture formed in the subterranean formation to prevent the fracture from being closed (blocked) and keep conductivity of a packed space of the subterranean formation (the fracture in the subterranean formation) in which the coated particles 1 are packed. This makes it possible to improve a flowing rate of hydrocarbon toward a wellbore formed so as to be communicate with the fracture.

The particles 2 serve as a propping agent in the fracture. Various kinds of particles having relatively high mechanical strength can be used as the particles 2 and the particles 2 are not limited to a specific kind. Concrete examples of the particles 2 include sand particles, ceramic particles, silica particles, metal particles and walnut shells.

Among the above particles, it is preferred that the plurality of particles 2 include at least one of a sand type particle and a ceramic type particle. Both of the sand type particle and the ceramic type particle have high mechanical strength and can be easily obtained at relatively low cost.

An average particle size of the plurality of particles 2 is preferably in the range of about 100 to 3,000 μm, and more preferably in the range of about 200 to 1,000 μm. By using the particles 2 having such an average particle size, it is possible to sufficiently keep the conductivity of the fracture in which the coated particles 1 are packed.

Further, the plurality of particles 2 may have variations in the particle size, and may contain one kind and another kind having about 10 times larger particle size than that of the one kind. Namely, when a size distribution of the plurality of particles 2 is measured, a half width of a peak of a particle size distribution curve expressed as a chevron function may be a relatively large value.

In FIG. 2, a cross-sectional shape of the particle 2 is depicted as a substantially circular shape, but may be an ellipsoidal shape, a polygonal shape, an irregular shape or the like. In these cases, a particle size of the particle 2 is defined as a maximum length in a cross-sectional shape thereof.

In the case of using the ceramic particles as the particles 2, it is preferred that each ceramic particle has a nearly circular shape as possible in the cross-sectional shape thereof. The ceramic particle having such a shape can have especially high mechanical strength. Further, by using such ceramic particles, it is possible to allow contacts among the coated particles 1 to be point contacts when the coated particles 1 are packed into the fracture. This makes it possible to increase volumes of spaces (channels) formed among the coated particles 1.

Further, sand particles obtained from the natural environment may be directly used as the particles 2. By using such sand particles as the particles 2, it is possible to improve productivity of the injection material 100 and save cost thereof. Furthermore, a mixture of the ceramic particles and the sand particles may be used as the particles 2. In this case, a mixing ratio of the ceramic particles to the sand particles is preferably in the range of about 1:9 to 9:1, and more preferably in the range of about 3:7 to 7:3 in a weight ratio.

At least a part of an outer surface of each particle 2 is covered with the surface layer 3. Even if the particles 2 packed in the fractures of the subterranean formation are collapsed into pieces due to the earth stress, this surface layer 3 can operate to prevent the pieces of each particle 2 from being scattered (spread) as shown in FIG. 3. This makes it possible to prevent the spaces (channels) among the coated particles 1 from being closed by the pieces of the particles 2, to thereby more reliably keep the conductivity of the fracture in which the coated particles 1 are packed.

A contained amount of the particles 2 in the whole of the injection material 100 is preferably in the range of about 5 to 50 wt %, and more preferably in the range of about 5 to 15 wt %. In the injection material containing the particles 2 in the above contained amount, it is possible to stably disperse the particles 2 regardless of a viscosity of the fluid.

Although the surface layer 3 preferably covers an entire of the outer surface of each particle 2 as shown FIG. 2 when the particles 2 are packed in the fracture formed in the subterranean formation, the surface layer 3 may cover only a part of the outer surface of each particle 2. Namely, in the state that the plurality of particles 2 are packed in the fracture formed in the subterranean formation, the entire of the outer surface of each of all of the particles 2 may be covered by the surface layer 3 or only a part of the outer surface of each of all of the particles 2 may be covered by the surface layer 3. Further, in the aforementioned state, the entire of the outer surface of each of some of the particles 2 may be covered by the surface layer 3 and only a part of the outer surface of each of the others of the particles 2 may be covered by the surface layer 3.

The surface layer 3 described above is formed from a cured material obtained by curing the acid-curing resin B contained in the resin composition due to the action of the acid-curing agent A. Hereinafter, description will be given to the acid-curing agent A and the acid-curing resin B.

The injection material 100 contains the acid-curing agent A and the acid-curing resin B which can cure in the presence of an acid, that is the acid-curing resin B which can cure due to the action of the acid-curing agent A as the resin composition of the present invention.

In the injection material (resin composition) 100 described above, the acid group contained in the acid-curing agent A having a reactivity with respect to the acid-curing resin B is present in a state that the acid group is blocked by the compound having a reactivity with respect to the acid group (hereinafter, this compound is sometimes referred to as “blocking compound”). Further, the blocking compound is designed so as to leave from the acid-curing agent A so that the acid-curing resin B starts to cure at a temperature in the range of 50 to 110° C. and within time in the range of 2 to 8 hours.

By blocking the acid group contained in the acid-curing agent A with the blocking compound as described above, it is possible to prevent the acid-curing agent A and the acid-curing resin B from contacting (reacting) with each other at an undesired location, and thereby preventing the acid-curing resin B from curing at the undesired location. Further, since the blocking compound leaves from the acid agent A at a necessary (target) location (that is, in the fracture formed in the subterranean formation), it is possible to allow the acid-curing agent A and the acid-curing resin B to contact (react) with each other to cure the acid-curing resin B at the necessary location. Namely, at the undesired location, the acid-curing agent A is in an inactive state that its function of curing the acid-curing resin B (the reactivity) is inactivated because the acid-curing agent A is blocked by the blocking compound at the undesired location. On the other hand, at the necessary location, the acid-curing agent A can cure the acid-curing resin B because the blocking compound leaves from the acid-curing agent A at the necessary location. More specifically, since the leaving of the blocking compound from the acid-curing agent A is designed so that the acid-curing resin B starts to cure at the temperature in the range of 50 to 110° C. and within the time in the range of 2 to 8 hours, the acid-curing agent A can selectively cure the acid-curing resin B at the necessary location without curing the acid-curing resin B at the undesired location.

In this regard, the word of “blocking” in the specification means that a functional group contained in the blocking compound chemically bonds with the acid group contained in the acid-curing agent A to inactivate the reactivity of the acid group (the reactivity with respect to the acid-curing resin B) for progressing the curing of the acid-curing resin B. Further, the words of “releasing of blocking” in the specification mean a state that the functional group contained in the blocking compound leaves from the acid group contained in the acid-curing agent A and the reactivity of the acid group for progressing the curing of the acid-curing resin B is activated.

Furthermore, the “chemical bonding” may be any bonding as long as it can inactivate the reactivity for progressing the curing of the acid-curing resin due to the reaction between the functional group contained in the blocking compound and the acid group contained in the acid-curing agent A. Examples of the chemical bonding include an intramolecular bonding such as a covalent bonding and a coordination bonding and a chemical bonding among molecules such as an ionic bonding and a hydrogen bonding.

The acid-curing resin B preferably cures at a temperature equal to or less than 110° C., more preferably cures at a temperature equal to or less than 75° C., and even more preferably cures at a temperature equal to or less than 25° C. (room temperature) due to the action of the acid-curing agent which is not blocked (unblocked product of the acid-curing agent A). Namely, after the blocking compound leaves, the acid-curing resin B preferably starts to cure at the temperature equal to or less than 110° C., more preferably starts to cure at the temperature equal to or less than 75° C., and even more preferably starts to cure at the temperature equal to or less than 25° C. (room temperature) due to the above action of the blocking compound. By using such an acid-curing resin B, it is possible to suitably use the injection material (resin composition) 100 in a case of recovering hydrocarbon from a subterranean formation located at a relatively shallow position. Further, even if the acid-curing resin B cures at a relatively low temperature due to the action of the acid-curing agent A as described above, the resin composition (injection material 100) of the present invention is present in the state that the acid group contained in the acid-curing agent A among the acid-curing agent A and the acid-curing resin B is blocked by the blocking compound. Thus, it is possible to adequately prevent the acid-curing resin B from curing before the blocking compound leaves from the acid-curing agent A.

Examples of such an acid-curing resin B include a furan resin, a phenol resin, a melamine resin, an urea resin and an oxetane resin. These resins may be used singly or in combination of two or more of them. Among them, the acid-curing resin B preferably contains at least one selected from the group consisting of the furan resin and the phenol resin. These acid-curing resins containing the above resins are especially suitable for the use of the present invention because these acid-curing resins easily start to cure at about room temperature in the presence of an acid such as the acid-curing agent A (the acid group contained in the acid-curing agent A). Further, by using these resins, it is possible to impart significantly high mechanical strength to the surface layer 3.

Examples of the furan resin include a furfural resin, a furfural phenol resin, a furfural ketone resin, a furfuryl alcohol resin and a furfuryl alcohol phenol resin. These resins may be used singly or in combination of two or more of them. Examples of the furfural resin include a monomer, an oligomer and a homopolymer of furfural. These furfural resins may be used singly or in combination of two of more of them. Examples of the furfural phenol resin include a mixture of a furfural resin and a phenol resin. Examples of the furfuryl alcohol resin include a monomer, an oligomer and a homopolymer of furfuryl alcohol. These furfuryl alcohol resins may be used singly or in combination of them. Examples of the furfuryl alcohol phenol resin include a mixture of a furfuryl alcohol resin and a phenol resin.

Among them, the furan resin is preferably a mixture of the furfural resin and the furfuryl alcohol resin. More specifically, the furan resin is more preferably a mixture of a copolymer of furfural and furfuryl alcohol, a monomer of furfural and a monomer of furfuryl alcohol. By using such a mixture, it is possible to remarkably provide the effect caused by using the furan resin as the acid-curing resin B.

In the case of using the above mixture as the furan resin, a weight average molecular weight of the mixture is not particularly limited to a specific value, but is preferably in the range of 500 to 500,000, and more preferably in the range of 10,000 to 30,000. By setting the weight average molecular weight to fall within the above range, it is possible to prevent the furan resin (acid-curing resin B) from precipitating in the injection material 100 (resin composition) and allow the furan resin to start to cure in a state that the furan resin adheres (entwines) to the particles 2 when the injection material 100 is injected in the fracture formed in the subterranean formation. Thus, it is possible to reliably produce the coated particles 1 by covering each particle 2 with the surface layer 3 in the fracture.

A representative method for producing the copolymer of furfuryl alcohol and furfural includes adding an acid into a mixture of furfuryl alcohol and furfural and then heating them to react with each other. After the reaction, by neutralizing the resulting resin with an alkali to suppress a progress of the reaction, it is possible to storage the resulting resin with keeping an appropriate viscosity. Further, it is possible to change a reactivity of the resin depending on a neutralization condition. Namely, the reactivity becomes high if a pH value of the resin is low and the reactivity becomes low if the pH value of the resin is high. Furthermore, it is also possible to produce the copolymer by heating and reacting a furfuryl alcohol after adding an acid to the furfuryl alcohol and then again heating and reacting the furfuryl alcohol after adding furfural to the furfuryl alcohol.

The acid is not particularly limited to a specific kind as long as it can set a pH value in a reaction system to be equal to or less than 3. Examples of the acid include a hydrochloric acid, a sulfuric acid and a p-toluenesulfonic acid. These acids may be used singly or in combination of two or more of them.

Further, a copolymer of furfuryl alcohol and aldehyde other than furfural may be used. Specifically, it is possible to use a copolymer of aldehyde and furfuryl alcohol obtained by using formaldehyde, paraformaldehyde, trioxane, acetaldehyde, propionaldehyde, polyoxymethylene, chloral, hexamethylenetetramine, furfural, glyoxal, n-butylaldehyde, caproaldehyde, allyl aldehyde, benzaldehyde, crotonaldehyde, acrolein, tetraoxymethylene, phenylacetaldehyde, o-tolualdehyde, salicylaldehyde, paraxylene dimethyl ether or the like.

Examples of the phenol resin include a resol-type phenol resin, an alkylene etherification resol-type phenol resin, a dimethylene ether-type phenol resin, an aminomethyl-type phenol resin, a novolac-type phenol resin, an aralkyl-type phenol resin and a dicyclopentadiene-type phenol resin.

Among them, the resol-type phenol resin is preferably used. The resol-type phenol resin can be obtained by mixing phenols and aldehydes, adding a base to the resulting mixture and heating the resulting mixture under a basic condition to react them with each other. By neutralizing the obtained resin with an acid after the reaction, it is possible to suppress an increasing of viscosity of the resin alone.

Examples of the phenols include phenol; cresol such as o-cresol, m-cresol and p-cresol; xylenol such as 2,3-xylenol, 2,4-xylenol, 2,5-xylenol, 2,6-xylenol, 3,4-xylenol and 3,5-xylenol; ethylphenol such as o-ethylphenol, m-ethylphenol and p-ethylphenol; isopropylphenol; butylphenol such as butylphenol and p-tert-butylphenol; alkylphenol such as p-tert-amylphenol, p-octylphenol, p-nonylphenol and p-cumylphenol; a monohydric phenol substitution such as p-phenylphenol, aminophenol, nitrophenol, dinitrophenol, trinitrophenol and cardanol; a monohydric phenol such as 1-naphthol and 2-naphthol; a polyhydric phenol such as resorcin, alkylresorcin, pyrogallol, catechol, alkylcatechol, hydroquinone, alkylhydroquinone, phloroglucin, bisphenol-A, bisphenol-F, bisphenol-S and dihydroxynaphthalene; and oil and fat such as cashew nut oil containing a phenol-based compound. Although it is also possible to use a halogenated phenol such as fluorophenol, chlorophenol, bromophenol and iodophenol, it is preferable to use phenols containing no halogen from the view point of the environment aspect. These phenols may be used singly or in combination of two of more of them. Examples of the aldehydes include formaldehyde, paraformaldehyde, trioxane, acetaldehyde, propionaldehyde, polyoxymethylene, chloral, hexamethylenetetramine, furfural, glyoxal, n-butylaldehyde, caproaldehyde, allyl aldehyde, benzaldehyde, crotonaldehyde, acrolein, tetraoxymethylene, phenylacetaldehyde, o-tolualdehyde, salicylaldehyde and paraxylene dimethyl ether. These aldehydes may be used singly or in combination of two or more of them. Examples of the base include a hydroxide of an alkali metal such as sodium hydroxide, lithium hydroxide and potassium hydroxide; ammonia water; a tertiary amine such as triethylamine; an oxide and a hydroxide of an alkali earth metal such as calcium, magnesium and barium; and an alkaline material such as sodium carbonate and hexamethylenetetramine. These bases may be used singly or in combination of two or more of them. Examples of the acid include an acid such as a sulfuric acid, an oxalic acid, a hydrochloric acid, a diethyl sulfate and a paratoluenesulfonic acid; and a metallic salt such as a zinc acetate. These acids may be used singly or in combination of two or more of them.

On the other hand, the acid-curing agent A serves as a catalyst for facilitating the curing reaction of the acid-curing resin B when the blocking by the blocking compound is released.

The acid-curing agent A described above may be any agent as long as it has an acid group and can provide the function as the catalyst due to the action of the acid group. Examples of the acid-curing agent A include an agent having a sulfonic acid group as the acid group such as p-toluenesulfonic acid, benzenesulfonic acid, dodecylbenzenesulfonic acid, phenolsulfonic acid, naphthalene sulfonic acid, dinonylnaphthalene sulfonic acid, dinonylnaphthalene disulfonic acid, xylenesulfonic acid and methanesulfonic acid; and an agent having a carboxyl group as the acid group such as an acetic acid, a lactic acid, a maleic acid, a benzoic acid and a fluoro acid. These agents may be used singly or in combination of two or more of them.

Among them, the agent containing the sulfonic acid group as the acid group is preferably used as the acid-curing agent A. Such an acid-curing agent A having the sulfonic acid group as the acid group is an excellent catalyst for the acid-curing resin B and can allow the blocking compound to reliably block the acid group.

Among the acid-curing agents A containing the sulfonic acid group as the acid group, it is preferable that the acid-curing agent A contains at least one selected from the group consisting of the p-toluenesulfonic acid, the benzenesulfonic acid, the dodecylbenzenesulfonic acid, the phenolsulfonic acid, the naphthalene sulfonic acid, the dinonylnaphthalene sulfonic acid and the dinonylnaphthalene disulfonic acid. In particular, it is more preferable that the acid-curing agent A contains the p-toluenesulfonic acid. By using these acid-curing agents A, especially by using the p-toluenesulfonic acid, it is possible to more reliably allow the blocking compound to block the acid group.

A contained amount of the acid-curing agent A is preferably in the range of about 0.25 to 20 parts by weight, more preferably in the range of about 0.5 to 15 parts by weight, and even more preferably in the range of about 0.5 to 10 parts by weight with respect to 100 parts by weight of the acid-curing resin B. By setting the contained amount of the acid-curing agent to fall within the above range, it is possible to ensure the acid-curing agent A in a sufficient amount for curing the acid-curing resin B even in a case where about half of the blocking by the blocking compound are not released due to a certain factor when the injection material 100 is injected in the fracture formed in the subterranean formation. As a result, it is possible to allow the acid-curing resin B to start to cure at the temperature in the range of 50 to 110° C. and within the time in the range of 2 to 8 hours due to the action of the acid-curing agent A.

Further, the compound (blocking compound) having the reactivity with respect to the acid group contained in the acid-curing agent A has the function of blocking the acid group contained in the acid-curing agent A to prevent the acid-curing agent A and the acid-curing resin B from reacting with each other at an undesired location, and thereby preventing the acid-curing resin B from curing at the undesired location. Furthermore, the blocking compound also has the function of leaving from the acid-curing agent A at a necessary location to react the acid-curing agent A with the acid-curing resin B, and thereby allowing the acid-curing resin B to cure at the necessary location.

Specifically, the blocking compound is designed so as to leave from the acid-curing agent A so that the acid-curing resin B starts to cure at the temperature in the range of 50 to 110° C. and within the time in the range of 2 to 8 hours. By designing the blocking compound in this manner, it is possible to provide the function of selectivity curing the acid-curing resin B at a necessary location without curing the acid-curing resin B at an undesired location.

Further, by blocking the acid group contained in the acid-curing agent A with the blocking agent, it is possible to use neutral range liquid as the fluid 20 of the injection material 100, and thereby reducing an environmental burden. Furthermore, there is an advantage that it is possible to reliably prevent an acid corrosion of a pipeline through which the injection material 100 passes when the injection material 100 is injected in the fracture.

Such a blocking compound has a functional group and can block the acid-curing agent because this functional group chemically bonds with the acid group contained in the acid-curing agent A.

The functional group may be any group as long as it can react with the acid group to couple (chemically bond) the blocking compound with the acid-curing agent A. Examples of the functional group include a hydroxyl group and an amino group. These functional groups may be used singly or in combination of two or more of them. Since the compound having such a functional group has a superior reactivity with respect to the acid group contained in the acid-curing agent A, it is possible to react (chemically bond) the functional group with the acid group to reliably block the acid-curing agent A with the blocking compound.

Examples of the blocking compound having the hydroxyl group as the functional group include an alkyl alcohol such as a monohydric alkyl alcohol and a polyhydric alkyl alcohol; an alkenyl alcohol; an aromatic alcohol and a heterocyclic ring-containing alcohol. Among them, the alkyl alcohol is preferably used as the blocking compound. By using such a blocking compound, it is possible to more reliably block the acid-curing agent A with the blocking compound.

Further, the monohydric alkyl alcohol may have a straight-chain type alkyl group, a branched type alkyl group or a ring type alkyl group as the alkyl group.

Specifically, examples of the straight-chain or branched type monohydric alkyl alcohol include a variety of primary to tertiary alcohols having different carbon numbers (lower alcohols or higher alcohols), namely, methanol; ethanol; propanol such as 1-propanol and 2-propanol; butanol such as 1-butanol, 2-butanol, 2-methyl-1-propanol and 2-methyl-2-propanol; pentanol such as 1-pentanol, 2-pentanol, 3-pentanol, 2-methyl-1-butanol, 3-methyl-1-butanol, 2-methyl-2-butanol and 2,2-dimethyl-1-propanol; hexanol such as 1-hexanol, 2-hexanol, 3-hexanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-1-pentanol, 4-methyl-2-pentanol, 2,3-dimethyl-2-butanol, 3,3-dimethyl-2-butanol and 2-ethyl-1-butanol; heptanol such as 1-heptanol, 2-heptanol, 3-heptanol, 2-methyl-1-hexanol, 2-methyl-1-hexanol, 2-methyl-2-hexanol, 2-methyl-3-hexanol, 5-methyl-2-hexanol, 3-ethyl-3-pentanol, 2,2-dimethyl-3-pentanol, 2,4-dimethyl-3-pentanol, 4,4-dimethyl-2-pentanol and 3-methyl-1-hexanol; octanol such as 1-octanol, 2-octanol, 3-octanol, 4-methyl-3-heptanol, 6-methyl-2-heptanol, 2-ethyl-1-hexanol, 2-propyl-1-pentanol, 2-methyl-1-heptanol and 2,2-dimethyl-1-hexanol; nonanol such as 1-nonanol, 2-nonanol, 3,5,5-trimethyl-1-hexanol, 2,6-dimethyl-4-heptanol and 3-ethyl-2,2-dimethyl-3-pentanol; decanol such as 1-decanol, 2-decanol, 4-decanol, 3,7-dimethyl-1-octanol and 2,4,6-trimethylheptanol; octadecanol such as undecanol, dodecanol, tridecanol, tetradecanol, heptadecanol and heptadecanol; nonadecanol; eicosanol; heneicosanol; tricosanol; and tetracosanol. These alcohols may be used singly or in combination of two or more of them.

Examples of the ring type monohydric alkyl alcohol (cycloalkylalcohol) include cyclohexanols such as cyclopentanol, cycloheptanol, methylcyclopentanol cyclopentylmethanol, cyclohexylmethanol, 1-cyclohexylethanol, 2-cyclohexylethanol, 3-cyclohexylpropanol, 4-cyclohexylbutanol, cyclohexanol, methylcyclohexanol, dimethylcyclohexanol, tetramethylcyclohexanol, hydroxycyclohexanol, (1S,2R,5S)-2-isopropyl-5-methylcyclohexanol, butylcyclohexanol and 4-t-butylcyclohexanol. These cyclohexanols may be used singly or in combination of two or more of them.

Further, examples of the polyhydric alkyl alcohol include a dihydric alcohol such as ethylene glycol (1,2-ethanediol), 1,2-propanediol and 1,3-propanediol; a trihydric alcohol such as glycerin; and a tetrahydric alcohol such as pentaerythritol. These polyhydric alcohols may be used singly or in combination of two of more of them.

In the case of using the acid-curing agent, which has the sulfonic acid group as the acid group, as the acid-curing agent A, a sulfonic acid ester bonding is generated between the acid-curing agent A and the blocking compound having the hydroxyl group as the functional group. Due to this reaction, the acid-curing agent A is blocked by the blocking compound. Namely, a sulfonic acid ester is generated as the acid-curing agent A which is blocked by the blocking compound.

Further, examples of the blocking compound having the hydroxyl group as the functional group include an alkylamine such as a monohydric alkylamine and a polyhydric alkylamine, an alkenylamine, an aromatic amine and a heterocyclic ring-containing amine. Among them, the alkylamine is preferably used as the blocking compound. By using such a blocking compound, it is possible to more reliably block the acid-curing agent A with the blocking compound.

Examples of the monohydric alkylamine include a monoalkylamine such as hexylamine, heptylamine, octylamine, nonylamine, decylamine, undecylamine, dodecylamine, tridecylamine, tetradecylamine, pentadecylamine, hexadecylamine, octadecylamine, isopropylamine, isoamylamine and 3,3-dimethylbutylamine; a dialkylamine such as N-ethylbutylamine, dibutylamine, dipentylamine, dihexylamine, diheptylamine, dioctylamine, dinonylamine, didecylamine, N-methylcyclohexylamine and dicyclohexylamine; and a trialkylamine such as trimethylamine, triethylamine, tripropylamine, tributylamine and trioctylamine. These monohydric alkylamines may be used singly or in combination of two or more of them.

Further, examples of the polyhydric alkylamine include a diamine such as ethylenediamine, hexamethylenediamine, diethylenetriamine, triethylenetetramine, tetraethylenepentamine and pentaethylenehexamine and a triamine such as bis(hexamethylene)triamine. These polyhydric alkylamines may be used singly or in combination of two or more of them.

In the case of using the acid-curing agent, which has the sulfonic acid group as the acid group, as the acid-curing agent A, a salt is generated between the acid-curing agent A and the blocking compound having the amino group as the functional group due to the neutralization (ionic bonding). Due to this reaction, the acid-curing agent A is blocked by the blocking compound. Namely, a sulfonic acid amine salt is generated as the acid-curing agent A which is blocked by the blocking compound.

When the number of the acid groups contained in the acid-curing agent A is defined as “1”, the blocking compound contains the functional groups so that the number of the functional groups preferably satisfies a relationship of the number of the acid groups:the number of the functional groups=1:0.1 to 1:1.9, more preferably satisfies a relationship of the number of the acid groups:the number of the functional groups=1:0.3 to 1:1.7, and even more preferably satisfies a relationship of the number of the acid groups:the number of the functional groups=1:0.5 to 1:1.5.

Regarding the acid-curing resin B, the acid-curing agent A and the blocking compound as described above, a property of the resin composition of the present invention is set so that the acid-curing resin B starts to cure at the temperature in the range of 50 to 110° C. and within the time in the range of 2 to 8 hours by adjusting a kind and a contained amount of each of the acid-curing resin B, the acid-curing agent A and the blocking compound. Namely, by preferably selecting and setting the kind and the contained amount of each of the acid-curing resin B, the acid-curing agent A and the blocking compound, a curing start temperature of the acid-curing resin B is set to fall within the range of 50 to 110° C. and a curing start time of the acid-curing resin B is set to fall within the range of 2 to 8 hours.

Specifically, the curing start temperature and the curing start time can be respectively set to fall within the below ranges in the case of using a furan resin “a” as the acid-curing resin B prepared by the following manner and selecting paratoluenesulfonic acid as the acid-curing agent A. For example, the manner for preparing the furan resin “a” includes adding an acid into a furfuryl alcohol, heating the resulting mixture to react, adding a furfural into the resulting mixture so that a mole ratio of the furfuryl alcohol satisfies a relationship of a ratio of the furfuryl alcohol:the furfural=1:0 to 1:0.6, heating and reacting the resulting mixture until a viscosity of the resulting mixture becomes in the range of 100 to 500 cPs to obtain a copolymer, neutralizing the obtained copolymer with a base, heating the obtained copolymer under reduced pressure to remove water, adding a furfuryl alcohol monomer, a furfural monomer or a mixture thereof into the obtained copolymer at a ratio of 0 to 70 phr with respect to the copolymer, and adjusting a pH value of the resulting resin to fall within the range of 3.5 to 5 to prepare the furan resin “a”.

Namely, by selecting methanol as the blocking compound and setting the contained amount of the acid-curing agent A which is blocked (paratoluenesulfonic acid methyl) with respect to the acid-curing resin B to fall within the range of 5 to 10 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 2.5 to 5 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.5 to 2.5 parts by weight, it is possible to respectively set the curing start temperature and the curing start time to fall within the range of 50 to 70° C. and the range of 6 to 8 hours. In addition, by selecting ethanol as the blocking compound and setting the contained amount of the acid-curing agent A which is blocked (paratoluenesulfonic acid ethyl) with respect to the acid-curing resin B to fall within the range of 5 to 10 parts by weight, it is possible to respectively set the curing start temperature and the curing start time to fall within the range of 50 to 70° C. and the range of 6 to 8 hours.

In addition, by selecting the methanol as the blocking compound and setting the contained amount of the acid-curing agent A which is blocked (paratoluenesulfonic acid methyl) with respect to the acid-curing resin B to fall within the range of 0.5 to 1.5 parts by weight, it is possible to respectively set the curing start temperature and the curing start time to fall within the range of 70 to 90° C. and the range of 2 to 4 hours. Further, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 70 to 90° C. and the range of 4 to 6 hours. In addition, by selecting the ethanol or 1-propanol as the blocking compound and setting the contained amount of the acid-curing agent A which is blocked (paratoluenesulfonic acid ethyl or propyl) with respect to the acid-curing resin B to fall within the range of 1.5 to 5 parts by weight, it is possible to respectively set the curing start temperature and the curing start time to fall within the range of 70 to 90° C. and the range of 2 to 4 hours. Further, by setting the contained amount of the acid-curing agent A which is blocked with respect to the acid-curing resin B to fall within the range of 1 to 1.5 parts by weight, it is possible to respectively set the curing start temperature and the curing start time to fall within the range of 70 to 90° C. and the range of 4 to 6 hours. Furthermore, by setting the contained amount of the acid-curing agent A which is blocked with respect to the acid-curing resin B to fall within the range of 0.5 to 1 parts by weight, it is possible to respectively set the curing start temperature and the curing start time to fall within the range of 70 to 90° C. and the range of 6 to 8 hours. In addition, by selecting 1-hexanol as the blocking compound and setting the contained amount of the acid-curing agent A which is blocked (paratoluenesulfonic acid hexyl) with respect to the acid-curing resin B to fall within the range of 4 to 10 parts by weight, it is possible to respectively set the curing start temperature and the curing start time to fall within the range of 70 to 90° C. and the range of 2 to 4 hours. Further, by setting the contained amount of the acid-curing agent A which is blocked with respect to the acid-curing resin B to fall within the range of 2.5 to 4 parts by weight, it is possible to respectively set the curing start temperature and the curing start time to fall within the range of 70 to 90° C. and the range of 4 to 6 hours. Furthermore, by setting the contained amount of the acid-curing agent A which is blocked with respect to the acid-curing resin B to fall within the range of 3 to 5 parts by weight, it is possible to respectively set the curing start temperature and the curing start time to fall within the range of 70 to 90° C. and the range of 6 to 8 hours.

In addition, by selecting the methanol as the blocking compound and setting the contained amount of the acid-curing agent A which is blocked (paratoluenesulfonic acid methyl) with respect to the acid-curing resin B to fall within the range of 0.25 to 0.5 parts by weight, it is possible to respectively set the curing start temperature and the curing start time to fall within the range of 90 to 110° C. and the range of 2 to 4 hours. In addition, by selecting the ethanol as the blocking compound and setting the contained amount of the acid-curing agent A which is blocked (paratoluenesulfonic acid ethyl) with respect to the acid-curing resin B to fall within the range of 0.25 to 1.5 parts by weight, it is possible to respectively set the curing start temperature and the curing start time to fall within the range of 90 to 110° C. and the range of 2 to 4 hours. In addition, by selecting the 1-prophanol or the 1-hexanol as the blocking compound and setting the contained amount of the acid-curing agent A which is blocked (paratoluenesulfonic acid propyl or hexyl) with respect to the acid-curing resin B to fall within the range of 0.5 to 1.5 parts by weight, it is possible to respectively set the curing start temperature and the curing start time to fall within the range of 90 to 110° C. and the range of 2 to 4 hours. Further, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 90 to 110° C. and the range of 4 to 6 hours.

In addition, by selecting cyclohexanol as the blocking compound and setting the contained amount of the acid-curing agent A which is blocked (paratoluenesulfonic acid cyclohexyl) with respect to the acid-curing resin B to fall within the range of 4 to 5 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 1.5 to 4 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 50 to 70° C. and the range of 6 to 8 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 70 to 90° C. and the range of 2 to 4 hours.

In addition, by selecting an amine compound as the blocking compound and setting the contained amount of the acid-curing agent A which is blocked (paratoluenesulfonic acid amine salt) with respect to the acid-curing resin B to fall within the range of 4 to 5 parts by weight, it is possible to respectively set the curing start temperature and the curing start time to fall within the range of 90 to 110° C. and the range of 4 to 6 hours.

In addition, in the case of respectively selecting the furan resin “a” described above and dodecylbenzenesulfonic acid as the acid-curing resin B and the acid-curing agent A, by setting the contained amount of the acid-curing agent A which is blocked (dodecylbenzenesulfonic acid ester) with respect to the acid-curing resin B to fall within the range of 1.5 to 4 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.25 to 5 parts by weight, it is possible to respectively set the curing start temperature and the curing start time to fall within the range of 50 to 70° C. and the range of 6 to 8 hours. Furthermore, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 70 to 90° C. and the range of 2 to 4 hours. Furthermore, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 90 to 110° C. and the range of 2 to 4 hours.

In addition, in the case of respectively selecting the furan resin “a” described above and dinonylnaphthalene sulfonic acid as the acid-curing resin B and the acid-curing agent A, by setting the contained amount of the acid-curing agent A which is blocked (dinonylnaphthalene sulfonic acid ester) with respect to the acid-curing resin B to fall within the range of 2.5 to 4 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 1.5 to 2.5 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 50 to 70° C. and the range of 6 to 8 hours. Furthermore, by setting the contained amount of the acid-curing agent A which is blocked with respect to the acid-curing resin B to fall within the range of 1.5 to 2.5 parts by weight, it is possible to respectively set the curing start temperature and the curing start time to fall within the range of 70 to 90° C. and the range of 2 to 4 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 70 to 90° C. and the range of 4 to 6 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 90 to 110° C. and the range of 2 to 4 hours.

In addition, the curing start temperature and the curing start time can be respectively set to fall within the below ranges in the case of using a furan resin “b” prepared by the following manner as the acid-curing resin B and selecting the paratoluenesulfonic acid as the acid-curing agent A. The manner for preparing the furan resin “b” includes adding an acid into a furfuryl alcohol, heating the resulting mixture to react, adding a furfural into the resulting mixture so that a mole ratio of the furfuryl alcohol satisfies a relationship of a ratio of the furfuryl alcohol:the furfural=1:0 to 1:0.6, heating and reacting the resulting mixture until a viscosity of the resulting mixture becomes in the range of 100 to 500 cPs to obtain a copolymer, neutralizing the obtained copolymer with a base, heating the obtained copolymer under reduced pressure to remove water, adding a furfuryl alcohol monomer, a furfural monomer or a mixture thereof into the obtained copolymer at a ratio of 70 to 100 phr with respect to the copolymer, and adjusting a pH value of the resulting resin to fall within the range of 3.5 to 5 to prepare the furan resin “b”.

Namely, by selecting the methanol as the blocking compound and setting the contained amount of the acid-curing agent A which is blocked (paratoluenesulfonic acid methyl) with respect to the acid-curing resin B to fall within the range of 2.5 to 5 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 0.5 to 2.5 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.25 to 5 parts by weight, it is possible to respectively set the curing start temperature and the curing start time to fall within the range of 50 to 70° C. and the range of 6 to 8 hours. Furthermore, by setting the contained amount of the acid-curing agent A which is blocked (paratoluenesulfonic acid methyl) with respect to the acid-curing resin B to fall within the range of 0.25 to 0.5 parts by weight, it is possible to respectively set the curing start temperature and the curing start time to fall within the range of 70 to 90° C. and the range of 2 to 4 hours.

In addition, the curing start temperature and the curing start time can be respectively set to fall within the below ranges in the case of using a furan resin “c” prepared by the following manner as the acid-curing resin B and selecting the paratoluenesulfonic acid as the acid-curing agent A. The manner for preparing the furan resin “c” includes adding an acid into a furfuryl alcohol, heating and reacting the resulting mixture until a viscosity of the resulting mixture becomes in the range of 100 to 500 cPs to obtain a copolymer, neutralizing the obtained copolymer with a base, heating the obtained copolymer under reduced pressure to remove water, adding a furfuryl alcohol monomer, a furfural monomer or a mixture thereof into the obtained copolymer at a ratio of 0 to 100 phr with respect to the copolymer, and adjusting a pH value of the resulting resin to fall within the range of 5 to 8 to prepare the furan resin “c”.

Namely, by selecting the methanol as the blocking compound and setting the contained amount of the acid-curing agent A which is blocked (paratoluenesulfonic acid methyl) with respect to the acid-curing resin B to fall within the range of 1.5 to 5 parts by weight, it is possible to respectively set the curing start temperature and the curing start time to fall within the range of 70 to 90° C. and the range of 2 to 4 hours. Further, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 70 to 90° C. and the range of 4 to 6 hours.

In addition, the curing start temperature and the curing start time can be respectively set to fall within the below ranges in the case of using a furan resin “d” prepared by the following manner as the acid-curing resin B and selecting the paratoluenesulfonic acid as the acid-curing agent A. The manner for preparing the furan resin “d” includes adding an acid into a furfuryl alcohol, heating the resulting mixture to react, adding a furfural into the resulting mixture so that a mole ratio of the furfuryl alcohol satisfies a relationship of a ratio of the furfuryl alcohol:the furfural=1:0 to 1:0.3, heating and reacting the resulting mixture until a viscosity of the resulting mixture becomes in the range of 100 to 500 cPs to obtain a copolymer, neutralizing the obtained copolymer with a base, heating the obtained copolymer under reduced pressure to remove water, adding a furfuryl alcohol monomer, a furfural monomer or a mixture thereof into the obtained copolymer at a ratio of 0 to 100 phr with respect to the copolymer, and adjusting a pH value of the resulting resin to fall within the range of 5 to 8 to prepare the furan resin “d”.

Namely, by selecting the methanol as the blocking compound and setting the contained amount of the acid-curing agent A which is blocked (paratoluenesulfonic acid methyl) with respect to the acid-curing resin B to fall within the range of 10 to 20 parts by weight, it is possible to respectively set the curing start temperature and the curing start time to fall within the range of 50 to 70° C. and the range of 2 to 4 hours. Further, by setting the contained amount of the acid-curing agent A which is blocked (paratoluenesulfonic acid methyl) with respect to the acid-curing resin B to fall within the range of 5 to 10 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 2.5 to 5 parts by weight, it is possible to respectively set the curing start temperature and the curing start time to fall within the range of 50 to 70° C. and the range of 6 to 8 hours. Furthermore, by setting the contained amount of the acid-curing agent A which is blocked with respect to the acid-curing resin B to fall within the range of 1.5 to 5 parts by weight, it is possible to respectively set the curing start temperature and the curing start time to fall within the range of 70 to 90° C. and the range of 2 to 4 hours. Furthermore, by setting the contained amount of the acid-curing agent A which is blocked with respect to the acid-curing resin B to fall within the range of 5 to 10 parts by weight, it is possible to respectively set the curing start temperature and the curing start time to fall within the range of 70 to 90° C. and the range of 4 to 6 hours. Furthermore, by setting the contained amount of the acid-curing agent A which is blocked with respect to the acid-curing resin B to fall within the range of 0.5 to 1 parts by weight, it is possible to respectively set the curing start temperature and the curing start time to fall within the range of 90 to 100° C. and the range of 2 to 4 hours. Furthermore, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 90 to 110° C. and the range of 4 to 6 hours.

In addition, the curing start temperature and the curing start time can be respectively set to fall within the below ranges in the case of using a furan resin “e” prepared by the following manner as the acid-curing resin B and selecting the paratoluenesulfonic acid as the acid-curing agent A. The manner for preparing the furan resin “e” includes adding an acid into a furfuryl alcohol, heating the resulting mixture to react, adding a furfural into the resulting mixture so that a mole ratio of the furfuryl alcohol satisfies a relationship of a ratio of the furfuryl alcohol:the furfural=1:0.3 to 1:0.6, heating and reacting the resulting mixture until a viscosity of the resulting mixture becomes in the range of 100 to 500 cPs to obtain a copolymer, neutralizing the obtained copolymer with a base, heating the obtained copolymer under reduced pressure to remove water, adding a furfuryl alcohol monomer, a furfural monomer or a mixture thereof into the obtained copolymer at a ratio of 0 to 100 phr with respect to the copolymer, and adjusting a pH value of the resulting resin to fall within the range of 5 to 8 to prepare the furan resin “e”.

Namely, by selecting the methanol as the blocking compound and setting the contained amount of the acid-curing agent A which is blocked (paratoluenesulfonic acid methyl) with respect to the acid-curing resin B to fall within the range of 10 to 20 parts by weight, it is possible to respectively set the curing start temperature and the curing start time to fall within the range of 50 to 70° C. and the range of 2 to 4 hours. Further, by setting the contained amount of the acid-curing agent A which is blocked (paratoluenesulfonic acid methyl) with respect to the acid-curing resin B to fall within the range of 5 to 10 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 2.5 to 5 parts by weight, it is possible to respectively set the curing start temperature and the curing start time to fall within the range of 50 to 70° C. and the range of 6 to 8 hours. Furthermore, by setting the contained amount of the acid-curing agent A which is blocked with respect to the acid-curing resin B to fall within the range of 1.5 to 5 parts by weight, it is possible to respectively set the curing start temperature and the curing start time to fall within the range of 70 to 90° C. and the range of 2 to 4 hours. Furthermore, by setting the contained amount of the acid-curing agent A which is blocked with respect to the acid-curing resin B to fall within the range of 5 to 10 parts by weight, it is possible to respectively set the curing start temperature and the curing start time to fall within the range of 70 to 90° C. and the range of 4 to 6 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 90 to 110° C. and the range of 2 to 4 hours. Furthermore, by setting the contained amount of the acid-curing agent A which is blocked with respect to the acid-curing resin B to fall within the range of 0.25 to 0.5 parts by weight, it is possible to respectively set the curing start temperature and the curing start time to fall within the range of 90 to 110° C. and the range of 4 to 6 hours.

In addition, the curing start temperature and the curing start time can be respectively set to fall within the below ranges in the case of using a resol-type phenol resin “a” prepared by the following manner as the acid-curing resin B and selecting the paratoluenesulfonic acid as the acid-curing agent A. The manner for preparing the resol-type phenol resin “a” includes mixing a phenol and a formaldehyde so that a mole ratio satisfies a relationship of a ratio of the phenol:the formaldehyde=1:0.9 to 1:2.5, adding a base into the resulting mixture, heating the resulting mixture to react, adjusting a pH value of the resulting mixture to fall within the range of 4 to 9, and heating the resulting mixture under reduced presser to remove water to prepare the resol-type phenol resin “a”

Namely, by selecting the methanol as the blocking compound and setting the contained amount of the acid-curing agent A which is blocked (paratoluenesulfonic acid methyl) with respect to the acid-curing resin B to fall within the range of 2.5 to 5 parts by weight, it is possible to respectively set the curing start temperature and the curing start time to fall within the range of 50 to 70° C. and the range of 2 to 4 hours. Further, by setting the contained amount of the acid-curing agent A which is blocked with respect to the acid-curing resin B to fall within the range of 1.5 to 2.5 parts by weight, it is possible to respectively set the curing start temperature and the curing start time to fall within the range of 50 to 70° C. and the range of 4 to 6 hours. Furthermore, by setting the contained amount of the acid-curing agent A which is blocked with respect to the acid-curing resin B to fall within the range of 0.5 to 1.5 parts by weight, it is possible to respectively set the curing start temperature and the curing start time to fall within the range of 70 to 90° C. and the range of 4 to 6 hours.

Based on the aforementioned things, by selecting a monohydric alkyl alcohol having a large carbon number (higher alcohol) as the blocking compound, it is possible to strongly bond the blocking compound to the acid-curing agent A to obtain the acid-curing agent A. Such a blocking compound is preferably used for delaying the curing start time in a relatively high temperature region. In contrast, as the blocking compound, a monohydric alkyl alcohol having a small carbon number (lower alcohol) is preferably used for hastening the curing start time in a relatively low temperature region.

In this regard, a relationship between a primary alcohol and a secondary alcohol is the same as the relationship between the higher alcohol and the lower alcohol.

In the present invention, the property of the resin composition is set so that the acid-curing resin starts to cure at the temperature in the range of 50 to 110° and within the time in the range of 2 to 8 hours, but preferably set so that the acid-curing resin starts to cure at the temperature in the range of 60 to 100° and within the time in the range of 2 to 8 hours, and more preferably set so that the acid-curing resin starts to cure at the temperature in the range of 70 to 90° and within the time in the range of 4 to 6 hours.

Further, the property of the resin composition is preferably set so that the acid-curing resin B completes curing thereof within 48 hours, and more preferably set so that the acid-curing resin B completes the curing thereof within 24 hours. By setting the property of the resin composition as described above, it is possible to more reliably complete the curing of the acid-curing resin at a target location, and thereby more reliably covering each of the particles 2 with the surface layer 3 at the target location.

In this regard, the words of “the completion of the curing of the acid-curing resin B” in the specification mean a state that a cured material produced from a resin composition (mixture) obtained by mixing the acid-curing resin B and the acid-curing agent A which is blocked becomes a glassy solid and it becomes impossible to break the glassy solid by an examination by touch.

Based on the aforementioned things, in the case of respectively selecting the furan resin, the paratoluenesulfonic acid and the monohydric alkyl alcohol having the carbon number in the range of 1 to 6 as the acid-curing resin B, the acid-curing agent A and the blocking compound and setting the contained amount of the acid-curing agent A which is blocked with respect to 100 parts by weight of the acid-curing resin B to fall within the range of 0.25 to 10 parts by weight, it is possible to respectively set the curing start temperature and the curing start time of the acid-curing resin to fall within the range of 70 to 90° C. and the range of 4 to 6 hours. Thus, it can be said that this combination of the kind and the contained amount of each of the acid-curing resin B, and the acid-curing agent A and the blocking compound is preferable.

A method for producing the acid-curing agent whose acid group is blocked by the blocking compound is not particularly limited to a specific method. In the case where the acid-curing agent is a carboxylic acid having a carboxyl group and the blocking compound is phenols or an alcohol having a hydroxyl group, it is possible to produce a carboxylic acid ester which is the acid-curing agent whose acid group is blocked by, for example, mixing the carboxylic acid with the phenols or the alcohol and heating the resulting mixture with using a catalyst such as a concentrated sulfuric acid to cause a dehydration condensation reaction. Further, in the case where the acid-curing agent is a sulfonic acid having a sulfonic acid group and the blocking compound is phenols or alcohol having a hydroxyl group, it is possible to produce a sulfonic acid ester which is the acid-curing agent whose acid group is blocked by, for example, reacting a sulfonic acid chloride with the phenols or the alcohol with using a catalyst such as a pyridine. On the other hand, in the case where the acid-curing agent is a carboxylic acid having a carboxyl group or a sulfonic acid having a sulfonic acid group and the blocking compound is amines having an amino group, it is possible to produce a salt of the carboxylic acid or a salt of the sulfonic acid which is the acid-curing agent whose acid group is blocked by, for example, heating and mixing the carboxylic acid or the sulfonic acid with the amines to cause a neutralization reaction.

A contained amount of such a resin composition is preferably in the range of about 1 to 20 parts by weight, more preferably in the range of about 1 to 15 parts by weight, and even more preferably in the range of about 5 to 15 parts by weight with respect to 100 parts by weight of the particles 2. If the injection material 100 contains the resin composition in an amount of the above range, it is possible to reliably form the surface layers (covering layer) 3 on the outer surfaces of most of the particles 2 when the particles 2 are packed in the fracture formed in the subterranean formation.

As the fluid 20 used for preparing the injection material 100, it is preferable to use the same fluid as a fluid used for forming the fracture in the subterranean formation. A viscosity of such a fluid 20 at a temperature of 25° C. is preferably in the range of about 10 to 500 mPa·s, more preferably in the range of about 15 to 300 mPa·s, and even more preferably in the range of about 20 to 100 mPa·s. By using the fluid 20 having such a viscosity, it is possible to reliably form the fracture. Further, it is possible to improve a dispersibility of the particles 2 in the injection material 100, and thereby efficiently transferring and packing the particles 2 into the fracture.

The fluid 20 as described above preferably contains water as a main component thereof and a compound such as a gelatinizing agent and an electrolyte. By using such a compound, it is possible to easily and reliably adjust the viscosity of the fluid 20 to fall within the above range.

As the gelatinizing agent, for example, it is preferable to use polysaccharides such as cellulose, guar gum and a derivative thereof (for example, a hydroxylethyl derivative, a carboxymethyl hydroxyethyl derivative or a hydroxypropyl derivative). In this regard, a weight-average molecular weight of such a polysaccharide is preferably in the range of about 100,000 to 5,000,000, and more preferably in the range of about 500,000 to 3,000,000.

Examples of the electrolyte include sodium chloride, potassium chloride, ammonium chloride and calcium chloride. Further, it is also possible to prepare the fluid by adding the gelatinizing agent or the like into electrolyte aqueous solution existing in the nature (for example, seawater or brine solution).

Next, description will be given to a method for recovering the hydrocarbon from the subterranean formation.

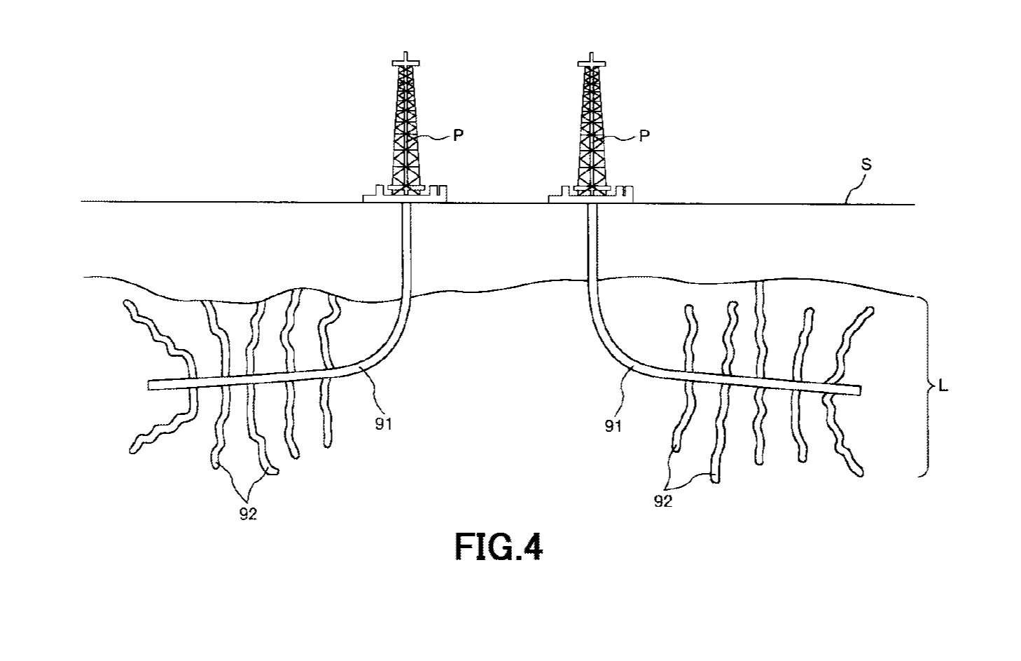

FIG. 4 is a conceptual view for explaining the method for recovering the hydrocarbon from the subterranean formation.

[1] First, as shown in FIG. 4, a wellbore 91 is dug from a land surface S to a target (objective) subterranean formation L containing the hydrocarbon in a vertical direction. After the wellbore 91 reaches the subterranean formation L, the digging direction thereof is changed to a horizontal direction and then the wellbore 91 is dug in the subterranean formation L until the wellbore 91 forwards a predetermined distance in the horizontal direction.

[2] Next, a fluid is injected into the subterranean formation L through the wellbore 91 at a predetermined rate and pressure. At this time, the fluid gradually breaks down soft parts of the subterranean formation L. In this way, a plurality of fractures 92 are formed in the subterranean formation L so as to be communicated with the wellbore 91.

[3] Next, the injection material 100 as described above is injected into the subterranean formation L through the wellbore 91 at a predetermined rate and pressure instead of the fluid. At this time, the injection material 100 is injected into each fracture 92 and the plurality of particles 2 are packed into each fracture 92.

Further, due to the pressure at the time of injecting the injection material 100 into the fractures 92 and/or the subterranean temperature, the blocking compound leaves from the acid-curing agent A. Due to this leaving of the blocking compound, the acid group contained in the acid-curing agent A is activated and the acid-curing agent A contacts and reacts with the acid-curing resin B in this state. At this time, the acid-curing resin B cures due to the action of the acid-curing agent A and the outer surface of each particle 2 is coated with the cured material of the acid-curing resin B. As a result, the coated particles 1 are produced.

In this regard, the blocking compound is designed so as to leave from the acid-curing agent for the first time due to the conditions such as the temperature and the pressure at the time of injecting the injection material 100 into the fractures 92 without leaving from the acid-curing agent at a preliminary stage before the injection material 100 is injected into the fractures 92, that is, when the injection material 100 passes through the wellbore 91 or the like. Thus, since the acid-curing agent A is blocked by the blocking compound at the preliminary step before the injection material 100 is injected into the fractures 92, the curing of the acid-curing resin B is prevented. Further, due to the leaving of the blocking compound at the time of injecting the injection material 100 into the fractures 92, the acid-curing agent A and the acid-curing resin B react with each other. As a result, the acid-curing resin B starts to cure in the fractures 92.

In this regard, this process [3] is preferably carried out with gradually increasing the amounts of the particles 2 and/or the resin composition in the injection material 100. With this process, it is possible to pack the particles 2 (coated particles 1) into each fracture 92 reliably and in high concentration.

The method including these processes [1] to [3] as described above is equivalent to the packing method of the present invention.

In the abovementioned manner, the coated particles 1 are packed into each fracture 92. As a result, it is possible to prevent each fracture 92 from being closed (blocked) due to the subterranean pressure. This makes it possible to improve a flowing rate of the hydrocarbon from the subterranean formation L to the wellbore 91, and thereby improving a recovery efficiency of the hydrocarbon.

[4] Next, the hydrocarbon is recovered from the subterranean formation L through each fracture 92 and the wellbore 91 with a pump P provided on the land surface S.

In this regard, the processes [2] and [3] may be simultaneously carried out with using the injection material 100. Namely, the plurality of particles 2 may be packed into each fracture 92 together with forming the plurality of fractures 92 in the subterranean formation L.

Here, although the resin composition, the injection material and the packing method of the present invention are described with reference to the embodiments, the present invention is not limited thereto.

### EXAMPLES

Hereinafter, the present invention will be described on the basis of embodiments in more detail.

### A. Method for Synthesizing the Acid-Curing Resin B

Furan resin 1: 0.9 g of hydrochloric acid (1.85 wt % aqueous solution) was added into 300 g of furfuryl alcohol to adjust a pH value to be equal to 2.5 (pH=2.5) and then the resulting mixture was heated at a temperature of 85° C. for 1 hour and 15 minutes to adjust a refractive index to be equal to 1.5. Then, the resulting mixture was cooled once and 150 g of furfural was added into the resulting mixture. Further, 3 g of hydrochloric acid (1.85 wt % aqueous solution) was added into the resulting mixture to adjust the pH value to be equal to 2.5 (pH=2.5) and the resulting mixture was heated at a temperature of 93°. This heating completed when a viscosity became 400 cPs. After that, the resulting mixture was cooled, 0.7 g of sodium hydroxide (50 wt % aqueous solution) was added into the resulting mixture and then a temperature of the resulting mixture was raised to 83° C. under reduced pressure (68 mmHg). Then, a furan resin 1 was obtained by cooling the resulting mixture under ordinary pressure and adding 45 g of furfuryl alcohol and 15 g of furfural into the resulting mixture.

Furan resin 2: 0.9 g of hydrochloric acid (1.85 wt % aqueous solution) was added into 300 g of furfuryl alcohol to adjust a pH value to be equal to 2.5 (pH=2.5) and then the resulting mixture was heated at a temperature of 85° C. for 1 hour and 15 minutes to adjust a refractive index to be equal to 1.5. Then, the resulting mixture was cooled once and 150 g of furfural was added into the resulting mixture. Further, 3 g of hydrochloric acid (1.85 wt % aqueous solution) was added into the resulting mixture to adjust the pH value to be equal to 2.5 (pH=2.5) and the resulting mixture was heated at a temperature of 93°. This heating completed when a viscosity became 400 cPs. After that, the resulting mixture was cooled, 0.7 g of sodium hydroxide (50 wt % aqueous solution) was added into the resulting mixture and then a temperature of the resulting mixture was raised to 83° C. under reduced pressure (68 mmHg). Then, a furan resin 2 was obtained by cooling the resulting mixture under ordinary pressure and adding 285 g of furfuryl alcohol and 95 g of furfural into the resulting mixture.

Furan resin 3: 0.9 g of hydrochloric acid (1.85 wt % aqueous solution) was added into 300 g of furfuryl alcohol to adjust a pH value to be equal to 2.5 (pH=2.5) and then the resulting mixture was heated at a temperature of 85° C. This heating completed when a viscosity became 400 cPs. After that, the resulting mixture was cooled, 0.8 g of sodium hydroxide (50 wt % aqueous solution) was added into the resulting mixture and then a temperature of the resulting mixture was raised to 83° C. under reduced pressure (68 mmHg). Then, a furan resin 3 was obtained by cooling the resulting mixture under ordinary pressure and adding 30 g of furfuryl alcohol into the resulting mixture.

Furan resin 4: 0.9 g of hydrochloric acid (1.85 wt % aqueous solution) was added into 300 g of furfuryl alcohol to adjust a pH value to be equal to 2.5 (pH=2.5) and then the resulting mixture was heated at a temperature of 85° C. for 1 hour and 15 minutes to adjust a refractive index to be equal to 1.5. Then, the resulting mixture was cooled once and 60 g of furfural was added into the resulting mixture. Further, 1.2 g of hydrochloric acid (1.85 wt % aqueous solution) was added into the resulting mixture to adjust the pH value to be equal to 2.5 (pH=2.5) and the resulting mixture was heated at a temperature of 93°. This heating completed when a viscosity became 400 cPs. After that, the resulting mixture was cooled, 0.9 g of sodium hydroxide (50 wt % aqueous solution) was added into the resulting mixture and then a temperature of the resulting mixture was raised to 83° C. under reduced pressure (68 mmHg). Then, a furan resin 4 was obtained by cooling the resulting mixture under ordinary pressure and adding 36 g of furfuryl alcohol into the resulting mixture.

Furan resin 5: 0.9 g of hydrochloric acid (1.85 wt % aqueous solution) was added into 300 g of furfuryl alcohol to adjust a pH value to be equal to 2.5 (pH=2.5) and then the resulting mixture was heated at a temperature of 85° C. for 1 hour and 15 minutes to adjust a refractive index to be equal to 1.5. Then, the resulting mixture was cooled once and 120 g of furfural was added into the resulting mixture. Further, 2.4 g of hydrochloric acid was added into the resulting mixture to adjust the pH value to be equal to 2.5 (pH=2.5) and the resulting mixture was heated at a temperature of 93°. This heating completed when a viscosity became 400 cPs. After that, the resulting mixture was cooled, 1.0 g of sodium hydroxide (50 wt % aqueous solution) was added into the resulting mixture and then a temperature of the resulting mixture was raised to 83° C. under reduced pressure (68 mmHg). Then, a furan resin 5 was obtained by cooling the resulting mixture under ordinary pressure and adding 42 g of furfuryl alcohol into the resulting mixture.

Resol-type phenol resin 1: phenol and aldehyde aqueous solution were mixed with each other so that a mole fraction satisfied a relationship of formaldehyde/phenol=2 and then potassium hydroxide was added to the resulting mixture to adjust a pH values to be equal to 8.7 (pH=8.7). After that, the resulting mixture was heated at a temperature of 60° C. for 30 minutes, heated at a temperature of 90° C. for 80 minutes and then heated at a temperature of 80° C. for 80 minutes. Then, the resulting mixture was cooled and neutralized with a sulfuric acid until the pH value became 6 (pH=6). Then, a resol-type phenol resin 1 was obtained by heating the resulting mixture under reduced pressure (70 mmHg) until a temperature of the resulting mixture became 95° C.

### 1. Forming the Coated Particles in the Injection Material

### 1-1. Producing the Resin Composition and the Injection Material

### Example 1A

First, a methyl p-toluenesulfonic acid (the acid-curing agent A: p-toluenesulfonic acid, the blocking compound: methanol; “PTSM”, MPTSA made by MRC UNITEC Co., Ltd.) was prepared as the acid-curing agent A whose acid group was blocked and the furan resin 1 was prepared as the acid-curing resin B. Further, the methyl p-toluenesulfonic acid and the furan resin 1 were mixed with each other so that an amount of a p-toluenesulfonic acid contained in the methyl p-toluenesulfonic acid became 5 parts by weight with respect to 100 parts by weight of the furan resin 1. As a result, a resin composition of example 1A was produced.

Next, an injection material of the example 1A was produced by mixing sand particles having an average particle size of 250 μm and the resin composition in liquid (fluid) used for the hydraulic fracturing.

A contained amount of the sand particles in the whole of the injection material was set to be 9 wt % and a contained amount of the resin composition was set to be 5 parts by weight with respect to 100 parts by weight of the particles.

### Example 2A

A resin composition and an injection material of example 2A were produced in the same manner as the example 1A except that a p-toluenesulfonic acid amine salt (the acid-curing agent A which was blocked by forming a sulfonamide bonding; “NACURE 2500” made by Kusumoto Chemicals, Ltd.) was used as the acid-curing agent A whose acid group was blocked.

### 1-2. Evaluation for Hardenability of the Resin Composition

Each of the obtained injection materials of the examples 1A and 2A was heated and pressured under conditions that a pressure was 6,000 psi and a temperature was 80° C.

As a result, it was confirmed that outer surfaces of the sand particles obtained from each of the injection materials of the examples 1A and 2A were coated (covered) with a cured material of a furfuryl alcohol resin.

### 2. Hardening Property of the Resin Composition

### 2-1. Producing the Resin Composition

### Example 1B

First, a methyl p-toluenesulfonic acid (the acid-curing agent A: p-toluenesulfonic acid, the blocking compound: methanol; “PTSM”, MPTSA made by MRC UNITEC Co., Ltd.) was prepared as the acid-curing agent A whose acid group was blocked and the furan resin 1 was prepared as the acid-curing resin B. Further, the methyl p-toluenesulfonic acid and the furan resin 1 were mixed with each other so that the amount of the methyl p-toluenesulfonic acid became 5 parts by weight with respect to 100 parts by weight of the furan resin 1. As a result, a resin composition of example 1B was produced.

### Example 2B

A resin composition of example 2B was produced in the same manner as the example 1B except that the resin composition was produced by mixing the methyl p-toluenesulfonic acid and the furan resin 1 so that the amount of the methyl p-toluenesulfonic acid became 1.5 parts by weight with respect to 100 parts by weight of the furan resin 1.

### Example 3B

A resin composition of example 3B was produced in the same manner as the example 1B except that the resin composition was produced by mixing the methyl p-toluenesulfonic acid and the furan resin 1 so that the amount of the methyl p-toluenesulfonic acid became 0.5 parts by weight with respect to 100 parts by weight of the furan resin 1.

### Example 1C

A resin composition of example 1C was produced in the same manner as the example 1B except that an ethyl p-toluenesulfonic acid (the acid-curing agent A: p-toluenesulfonic acid, the blocking compound: ethanol; “PTSE”, EPTSA made by MRC UNITEC Co., Ltd.) was prepared as the acid-curing agent A whose acid group was blocked.

### Example 2C

A resin composition of example 2C was produced in the same manner as the example 1C except that the resin composition was prepared by mixing the ethyl p-toluenesulfonic acid and the furan resin 1 so that the amount of the ethyl p-toluenesulfonic acid became 1.5 parts by weight with respect to 100 parts by weight of the furan resin 1.

### Example 3C

A resin composition of example 3C was produced in the same manner as the example 1C except that the resin composition was prepared by mixing the ethyl p-toluenesulfonic acid and the furan resin 1 so that the amount of the ethyl p-toluenesulfonic acid became 0.5 parts by weight with respect to 100 parts by weight of the furan resin 1.

### Example 1D

A resin composition of example 1D was produced in the same manner as the example 1B except that a propyl p-toluenesulfonic acid (the acid-curing agent A: p-toluenesulfonic acid, the blocking compound: 1-propanol; “propyl p-toluenesulfonic acid”, PPTSA made by Tokyo Chemical Industry Co., Ltd.) was prepared as the acid-curing agent A whose acid group was blocked.

### Example 2D

A resin composition of example 2D was produced in the same manner as the example 1D except that the resin composition was prepared by mixing the propyl p-toluenesulfonic acid and the furan resin 1 so that the amount of the propyl p-toluenesulfonic acid became 1.5 parts by weight with respect to 100 parts by weight of the furan resin 1.

### Example 3D

A resin composition of example 3D was produced in the same manner as the example 1D except that the resin composition was prepared by mixing the propyl p-toluenesulfonic acid and the furan resin 1 so that the amount of the propyl p-toluenesulfonic acid became 0.75 parts by weight with respect to 100 parts by weight of the furan resin 1.

### Example 4D

A resin composition of example 4D was produced in the same manner as the example 1D except that the resin composition was prepared by mixing the propyl p-toluenesulfonic acid and the furan resin 1 so that the amount of the propyl p-toluenesulfonic acid became 0.5 parts by weight with respect to 100 parts by weight of the furan resin 1.

### Example 1E

A resin composition of example 1E was produced in the same manner as the example 1B except that a hexyl p-toluenesulfonic acid (the acid-curing agent A: p-toluenesulfonic acid, the blocking compound: 1-hexanol; “hexyl p-toluenesulfonic acid”, HPTSA made by Tokyo Chemical Industry Co., Ltd.) was prepared as the acid-curing agent A whose acid group was blocked.

### Example 2E

A resin composition of example 2E was produced in the same manner as the example 1E except that the resin composition was prepared by mixing the hexyl p-toluenesulfonic acid and the furan resin 1 so that the amount of the hexyl p-toluenesulfonic acid became 2.5 parts by weight with respect to 100 parts by weight of the furan resin 1.

### Example 3E

A resin composition of example 3E was produced in the same manner as the example 1E except that the resin composition was prepared by mixing the hexyl p-toluenesulfonic acid and the furan resin 1 so that the amount of the hexyl p-toluenesulfonic acid became 1.5 parts by weight with respect to 100 parts by weight of the furan resin 1.

### Example 4E

A resin composition of example 4E was produced in the same manner as the example 1E except that the resin composition was prepared by mixing the hexyl p-toluenesulfonic acid and the furan resin 1 so that the amount of the hexyl p-toluenesulfonic acid became 0.5 parts by weight with respect to 100 parts by weight of the furan resin 1.

### Example 1F

A resin composition of example 1F was produced in the same manner as the example 1B except that a cyclohexyl p-toluenesulfonic acid (the acid-curing agent A: p-toluenesulfonic acid, the blocking compound: cyclohexanol; “cyclohexyl p-toluenesulfonic acid”, CHPTSA made by Tokyo Chemical Industry Co., Ltd.) was prepared as the acid-curing agent A whose acid group was blocked.

### Example 2F

A resin composition of example 2F was produced in the same manner as the example 1F except that the resin composition was prepared by mixing the cyclohexyl p-toluenesulfonic acid and the furan resin 1 so that the amount of the cyclohexyl p-toluenesulfonic acid became 2.5 parts by weight with respect to 100 parts by weight of the furan resin 1.

### Example 3F

A resin composition of example 3F was produced in the same manner as the example 1F except that the resin composition was prepared by mixing the cyclohexyl p-toluenesulfonic acid and the furan resin 1 so that the amount of the cyclohexyl p-toluenesulfonic acid became 0.5 parts by weight with respect to 100 parts by weight of the furan resin 1.

### Example 1G

A resin composition of example 1G was produced in the same manner as the example 1B except that a p-toluenesulfonic acid amine salt (the acid-curing agent A: p-toluenesulfonic acid, the blocking compound: an amine compound; “Nacure2500” made by King Co., Ltd.) was prepared as the acid-curing agent A whose acid group was blocked. In this regard, since the above product is a solvent-diluted product, the above product was added so that the amount of the p-toluenesulfonic amine salt became an objective amount.

### Example 1H

A resin composition of example 1H was produced in the same manner as the example 1B except that a dodecylbenzenesulfonic acid ester (the acid-curing agent A: dodecylbenzenesulfonic acid, the blocking compound: an alcohol compound; “Nacure5414” made by King Co., Ltd.) was prepared as the acid-curing agent A whose acid group was blocked. In this regard, since the above product is a solvent-diluted product, the above product was added so that the amount of the dodecylbenzenesulfonic acid ester became an objective amount.

### Example 2H

A resin composition of example 2H was produced in the same manner as the example 1H except that the resin composition was prepared by mixing the dodecylbenzenesulfonic acid ester and the furan resin 1 so that the amount of the dodecylbenzenesulfonic acid ester became 2.5 parts by weight with respect to 100 parts by weight of the furan resin 1.

### Example 3H

A resin composition of example 3H was produced in the same manner as the example 1H except that the resin composition was prepared by mixing the dodecylbenzenesulfonic acid ester and the furan resin 1 so that the amount of the dodecylbenzenesulfonic acid ester became 0.5 parts by weight with respect to 100 parts by weight of the furan resin 1.

### Example 1J

A resin composition of example 1J was produced in the same manner as the example 1B except that a dinonylnaphthalene sulfonic acid ester (the acid-curing agent A: dinonylnaphthalene sulfonic acid, the blocking compound: an alcohol compound; “Nacure1419” made by King Co., Ltd.) was prepared as the acid-curing agent A whose acid group was blocked. In this regard, since the above product is a solvent-diluted product, the above product was added so that the amount of the dinonylnaphthalene sulfonic acid ester became an objective amount.

### Example 2J

A resin composition of example 2J was produced in the same manner as the example 1J except that the resin composition was prepared by mixing the dinonylnaphthalene sulfonic acid ester and the furan resin 1 so that the amount of the dinonylnaphthalene sulfonic acid ester acid ester became 2.5 parts by weight with respect to 100 parts by weight of the furan resin 1.

### Example 3J

A resin composition of example 3J was produced in the same manner as the example 1J except that the resin composition was prepared by mixing the dinonylnaphthalene sulfonic acid ester and the furan resin 1 so that the amount of the dinonylnaphthalene sulfonic acid ester acid ester became 1.5 parts by weight with respect to 100 parts by weight of the furan resin 1.

### Example 4J

A resin composition of example 4J was produced in the same manner as the example 1J except that the resin composition was prepared by mixing the dinonylnaphthalene sulfonic acid ester and the furan resin 1 so that the amount of the dinonylnaphthalene sulfonic acid ester acid ester became 0.5 parts by weight with respect to 100 parts by weight of the furan resin 1.

### Example 1K

A resin composition of example 1K was produced in the same manner as the example 1B except that the furan resin 2 was used as the acid-curing resin B.

### Example 2K

A resin composition of example 2K was produced in the same manner as the example 1K except that the resin composition was prepared by mixing the methyl p-toluenesulfonic acid and the furan resin 2 so that the amount of the methyl p-toluenesulfonic acid became 2.5 parts by weight with respect to 100 parts by weight of the furan resin 2.

### Example 3K

A resin composition of example 3K was produced in the same manner as the example 1K except that the resin composition was prepared by mixing the methyl p-toluenesulfonic acid and the furan resin 2 so that the amount of the methyl p-toluenesulfonic acid became 1.5 parts by weight with respect to 100 parts by weight of the furan resin 2.

### Example 4K

A resin composition of example 4K was produced in the same manner as the example 1K except that the resin composition was prepared by mixing the methyl p-toluenesulfonic acid and the furan resin 2 so that the amount of the methyl p-toluenesulfonic acid became 0.5 parts by weight with respect to 100 parts by weight of the furan resin 2.

### Example 1L

A resin composition of example 1L was produced in the same manner as the example 1B except that the resin composition was prepared by mixing the methyl p-toluenesulfonic acid and the furan resin 3 so that the amount of the methyl p-toluenesulfonic acid became 10 parts by weight with respect to 100 parts by weight of the furan resin 3.

### Example 2L

A resin composition of example 2L was produced in the same manner as the example 1L except that the resin composition was prepared by mixing the methyl p-toluenesulfonic acid and the furan resin 3 so that the amount of the methyl p-toluenesulfonic acid became 5 parts by weight with respect to 100 parts by weight of the furan resin 3.

### Example 3L

A resin composition of example 3L was produced in the same manner as the example 1L except that the resin composition was prepared by mixing the methyl p-toluenesulfonic acid and the furan resin 3 so that the amount of the methyl p-toluenesulfonic acid became 2.5 parts by weight with respect to 100 parts by weight of the furan resin 3.

### Example 4L

A resin composition of example 4L was produced in the same manner as the example 1L except that the resin composition was prepared by mixing the methyl p-toluenesulfonic acid and the furan resin 3 so that the amount of the methyl p-toluenesulfonic acid became 1.5 parts by weight with respect to 100 parts by weight of the furan resin 3.

### Example 5L

A resin composition of example 5L was produced in the same manner as the example 1L except that the resin composition was prepared by mixing the methyl p-toluenesulfonic acid and the furan resin 3 so that the amount of the methyl p-toluenesulfonic acid became 0.5 parts by weight with respect to 100 parts by weight of the furan resin 3.

### Example 1M

A resin composition of example 1M was produced in the same manner as the example 1B except that the resin composition was prepared by mixing the methyl p-toluenesulfonic acid and the furan resin 4 so that the amount of the methyl p-toluenesulfonic acid became 10 parts by weight with respect to 100 parts by weight of the furan resin 4.

### Example 2M

A resin composition of example 2M was produced in the same manner as the example 1M except that the resin composition was prepared by mixing the methyl p-toluenesulfonic acid and the furan resin 4 so that the amount of the methyl p-toluenesulfonic acid became 5 parts by weight with respect to 100 parts by weight of the furan resin 4.

### Example 3M

A resin composition of example 3M was produced in the same manner as the example 1M except that the resin composition was prepared by mixing the methyl p-toluenesulfonic acid and the furan resin 4 so that the amount of the methyl p-toluenesulfonic acid became 2.5 parts by weight with respect to 100 parts by weight of the furan resin 4.

### Example 4M

A resin composition of example 4M was produced in the same manner as the example 1M except that the resin composition was prepared by mixing the methyl p-toluenesulfonic acid and the furan resin 4 so that the amount of the methyl p-toluenesulfonic acid became 1.5 parts by weight with respect to 100 parts by weight of the furan resin 4.

### Example 5M

A resin composition of example 5M was produced in the same manner as the example 1M except that the resin composition was prepared by mixing the methyl p-toluenesulfonic acid and the furan resin 4 so that the amount of the methyl p-toluenesulfonic acid became 0.5 parts by weight with respect to 100 parts by weight of the furan resin 4.

### Example 1N

A resin composition of example 1N was produced in the same manner as the example 1B except that the resin composition was prepared by mixing the methyl p-toluenesulfonic acid and the furan resin 5 so that the amount of the methyl p-toluenesulfonic acid became 15 parts by weight with respect to 100 parts by weight of the furan resin 5.

### Example 2N

A resin composition of example 2N was produced in the same manner as the example 1N except that the resin composition was prepared by mixing the methyl p-toluenesulfonic acid and the furan resin 5 so that the amount of the methyl p-toluenesulfonic acid became 5 parts by weight with respect to 100 parts by weight of the furan resin 5.

### Example 3N

A resin composition of example 3N was produced in the same manner as the example 1N except that the resin composition was prepared by mixing the methyl p-toluenesulfonic acid and the furan resin 5 so that the amount of the methyl p-toluenesulfonic acid became 2.5 parts by weight with respect to 100 parts by weight of the furan resin 5.

### Example 4N

A resin composition of example 4N was produced in the same manner as the example 1N except that the resin composition was prepared by mixing the methyl p-toluenesulfonic acid and the furan resin 5 so that the amount of the methyl p-toluenesulfonic acid became 1.5 parts by weight with respect to 100 parts by weight of the furan resin 5.

### Example 5N

A resin composition of example 5N was produced in the same manner as the example 1N except that the resin composition was prepared by mixing the methyl p-toluenesulfonic acid and the furan resin 5 so that the amount of the methyl p-toluenesulfonic acid became 0.5 parts by weight with respect to 100 parts by weight of the furan resin 5.

### Example 1O

A resin composition of example 1O was produced in the same manner as the example 1B except that the resol-type phenol resin 1 was used as the acid-curing resin B and the resin composition was prepared by mixing the methyl p-toluenesulfonic acid and the resol-type phenol resin 1 so that the amount of the methyl p-toluenesulfonic acid became 2.5 parts by weight with respect to 100 parts by weight of the resol-type phenol resin 1.

### Example 2O

A resin composition of example 2O was produced in the same manner as the example 1O except that the resin composition was prepared by mixing the methyl p-toluenesulfonic acid and the resol-type phenol resin 1 so that the amount of the methyl p-toluenesulfonic acid became 1.5 parts by weight with respect to 100 parts by weight of the resol-type phenol resin 1.

### Example 3O

A resin composition of example 3O was produced in the same manner as the example 1O except that the resin composition was prepared by mixing the methyl p-toluenesulfonic acid and the resol-type phenol resin 1 so that the amount of the methyl p-toluenesulfonic acid became 0.5 parts by weight with respect to 100 parts by weight of the resol-type phenol resin 1.

### Comparative Example 1B

A resin composition of comparative example 1B was produced in the same manner as the example 1B except that a p-toluenesulfonic acid which was the acid-curing agent A whose acid group was not blocked was prepared instead of the methyl p-toluenesulfonic acid which was the acid-curing agent A whose acid group was blocked.

### Comparative Example 2B

A resin composition of comparative example 2B was produced in the same manner as the example 1B except that the adding of the methyl p-toluenesulfonic acid which was the acid-curing agent A whose acid group was blocked was omitted.

### 2-2. Evaluation for the Hardening Property

Water was added into the resin composition of each of the examples 2B, 3B, 2C, 3C, 2D, 4D, 3E, 4E, 1G, 3H, 4J, 4L, 5L, 4M, 5M, 4N and 5N and the comparative example 2B so that a ratio by weight of the resin and the water satisfied a ratio of 2:1. Then, each of the resulting mixtures in this state was heated at a temperature of 100° C. for 32 hours. A curing situation (degree) of each of the resulting mixtures was observed for every a predetermined time period by an examination by touch.

Further, water was added into the resin composition of each of the examples 1B to 3B, 1C to 3C, 1D to 3D, 1E to 3E, 3F, 3H, 2J, 3J, 4K, 2L to 4L, 4M, 5M, 4N, 5N and 30 so that a ratio by weight of the resin and the water satisfied a ratio of 2:1. Then, each of the resulting mixtures in this state was heated at a temperature of 80° C. for 32 hours. A curing situation (degree) of each of the resulting mixtures was observed for every predetermined time period by an examination by touch.

Furthermore, water was added into the resin composition of each of the examples 1B, 2B, 1C, 2C, 1E, 3E, 1F, 2F, 1H, 2H, 1J to 3J, 1K to 3K, 1L, 2L, 1M to 3M, 1N to 3N and 10 to 30 and the comparative examples 1B and 2B so that a ratio by weight of a solid component of the furan resin and the water satisfied a ratio of 1:1. Then, each of the resulting mixtures in this state was heated at a temperature of 60° C. for 32 hours. A curing situation (degree) of each of the resulting mixtures was observed for every predetermined time period by an examination by touch.

The curing situation (degree) by the examination by touch was evaluated with the following criteria. The criteria include 1: liquid, 2: high-viscosity liquid, 3: gel (it is easy to break the cured material), 4: a rubber state solid and 5: a glassy solid (it is impossible to break the cured material).

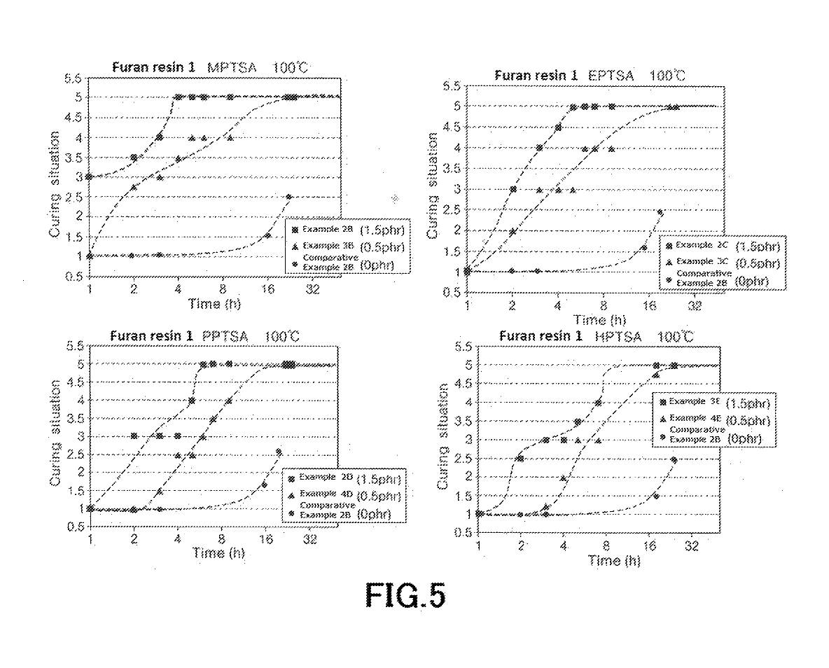

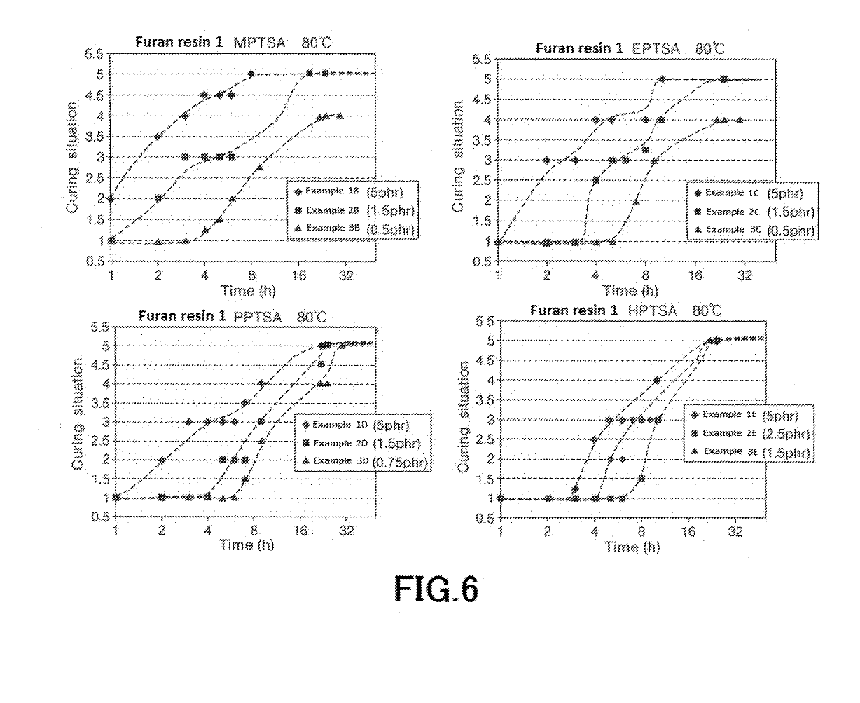

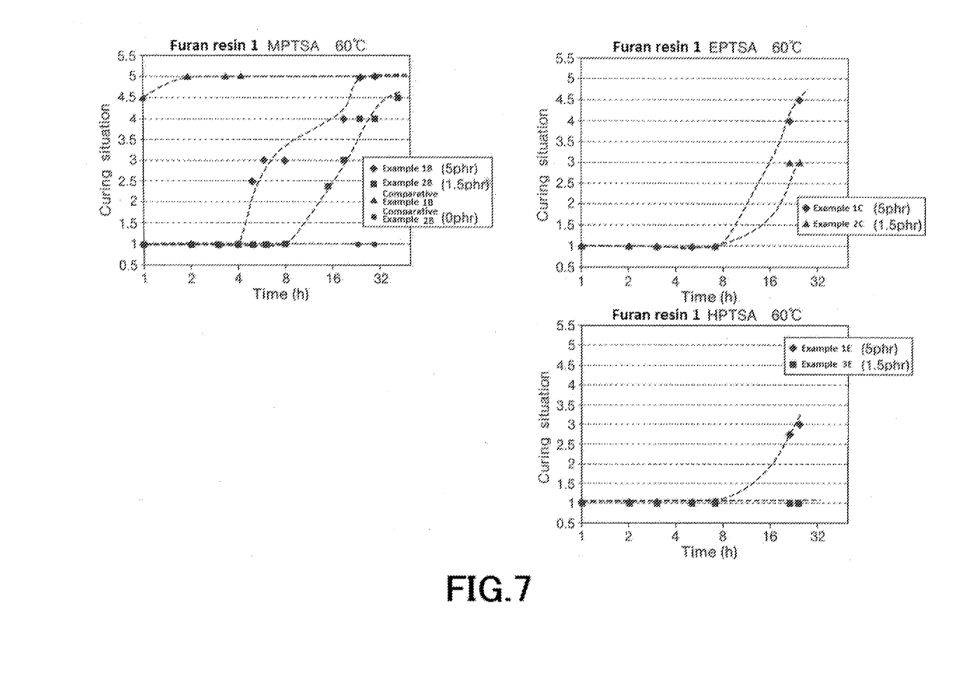

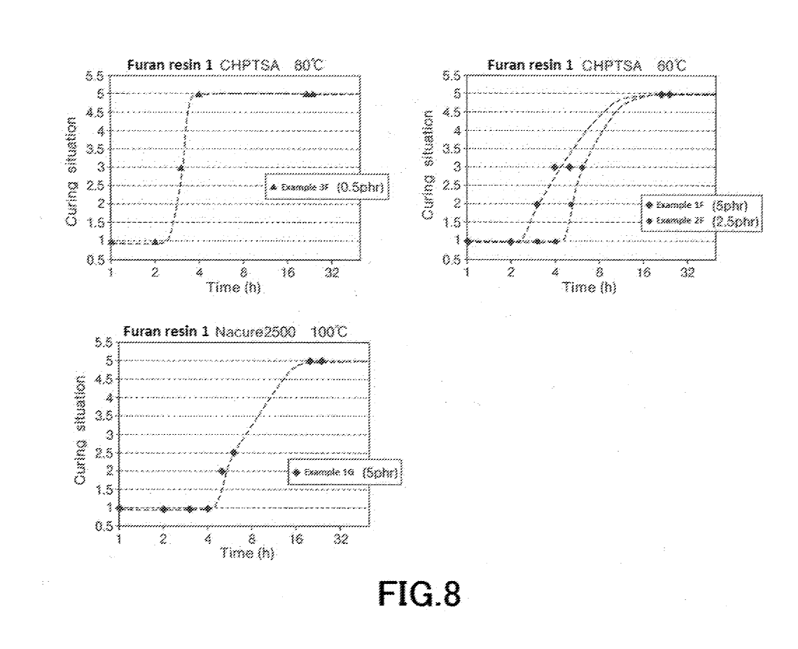

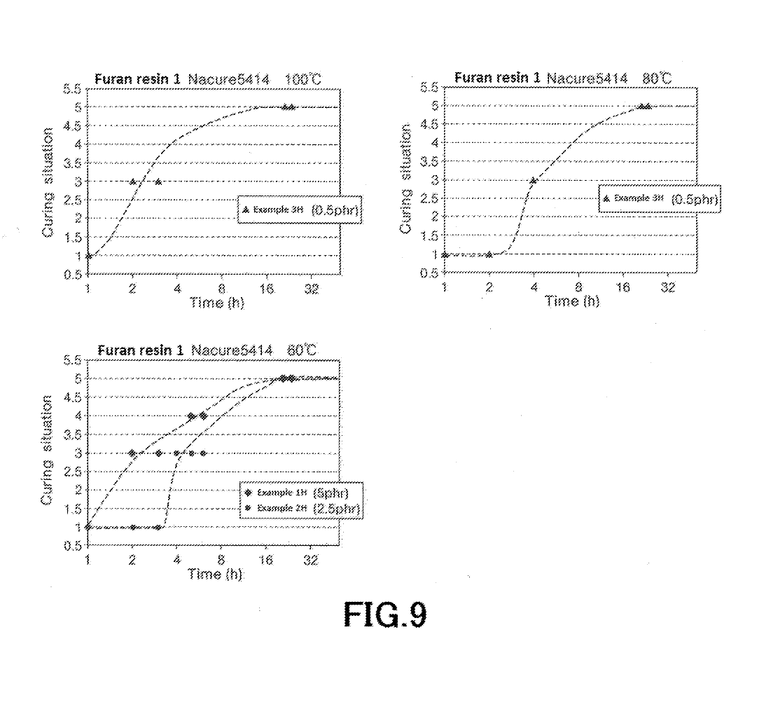

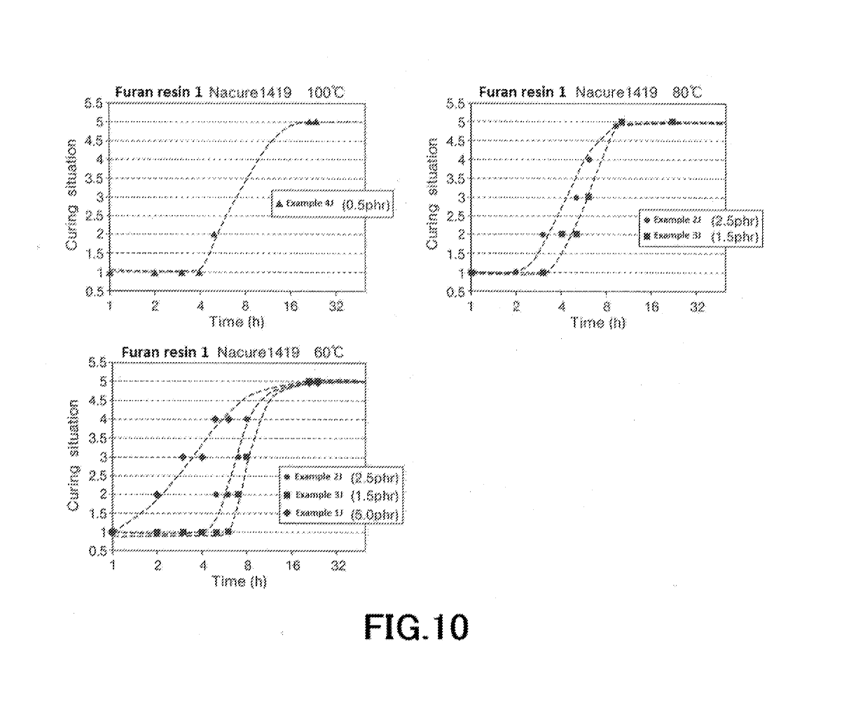

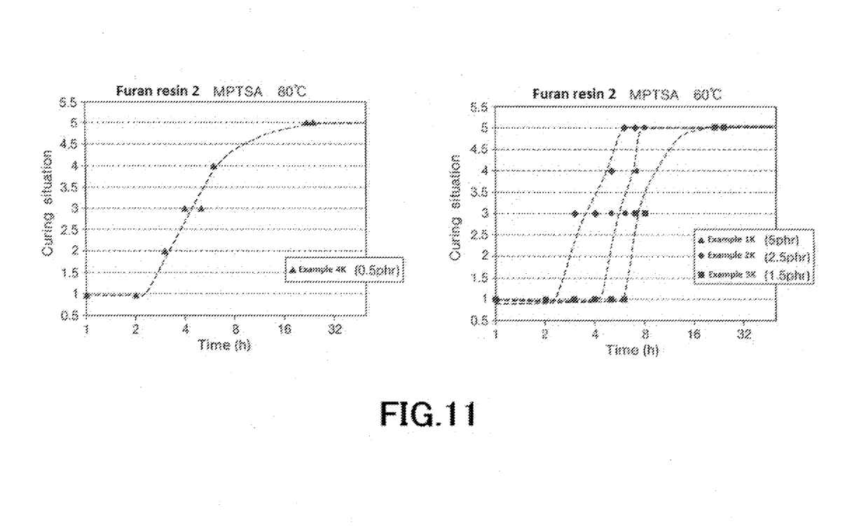

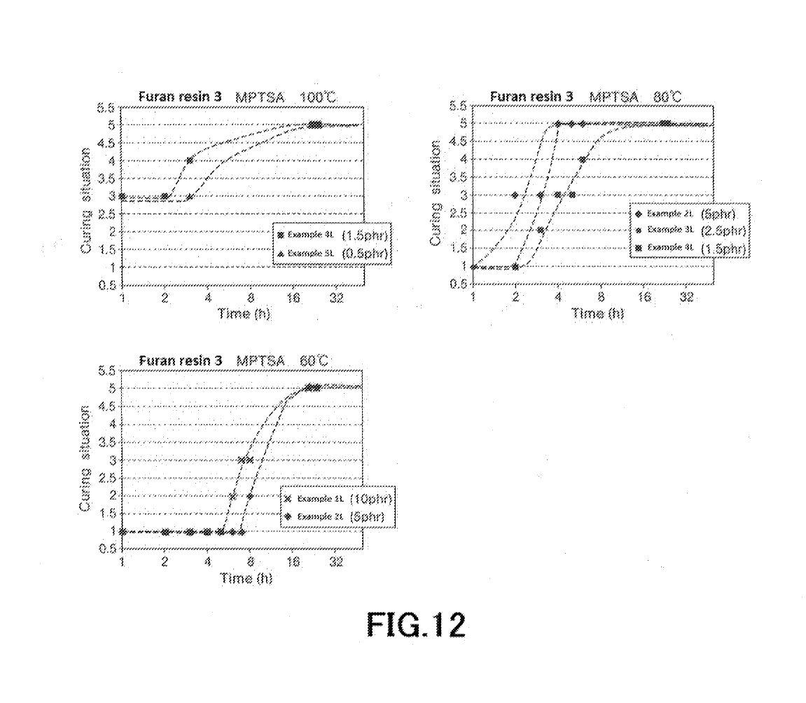

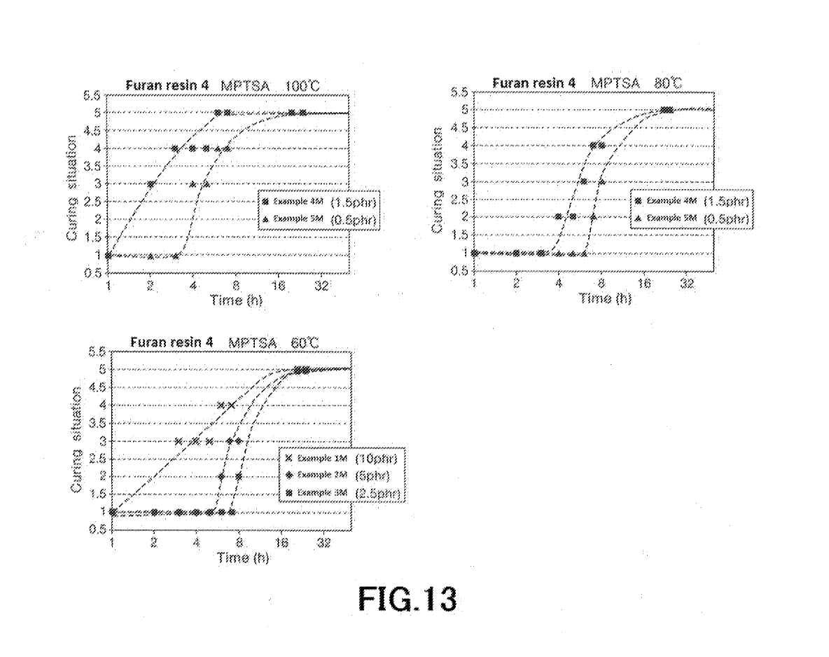

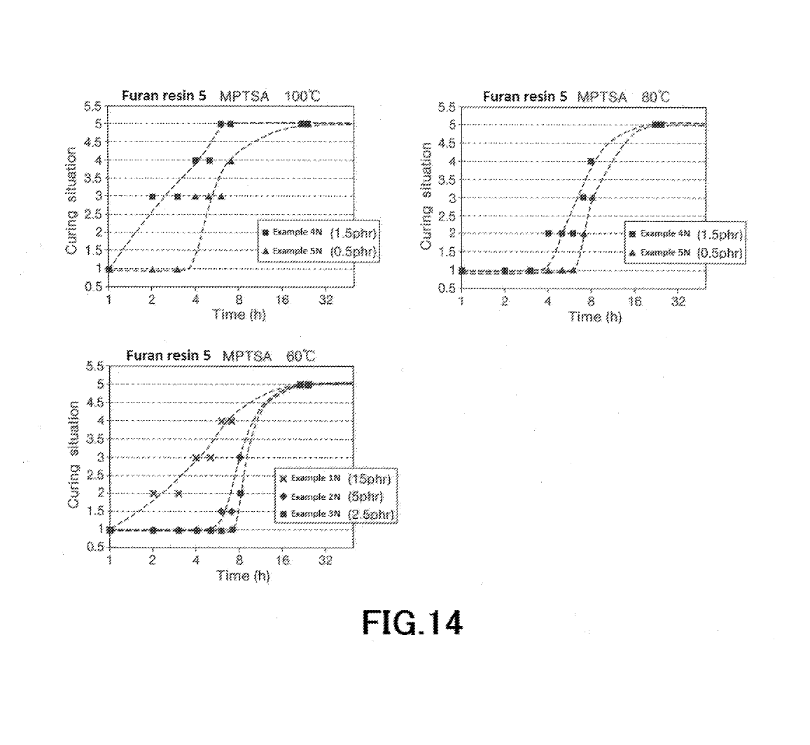

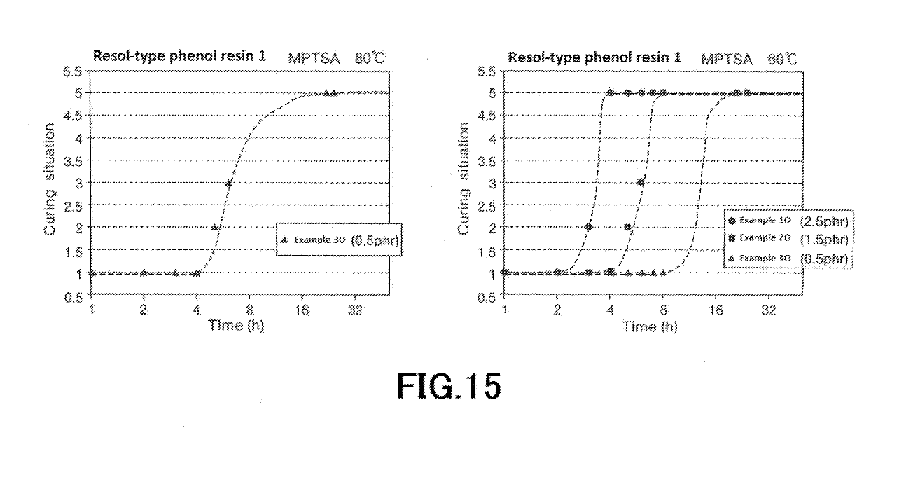

The obtained results are shown in FIGS. 5 to 15.

As shown in FIGS. 5 to 15, in the resin composition of each of the examples, by adjusting the kind and the contained amount of each of the acid-curing agent A whose acid group is blocked and the acid-curing resin B, it is achieved to set the property of the resin composition so that the acid-curing resin B starts to cure at the temperatures of 60° C., 80° C. and 100° C. within the time in the range of 2 to 8 hours. On the other hand, in the resin composition of each of the comparative examples, it is not achieved to set the property of the resin composition so that the acid-curing resin B starts to cure under the above conditions.

### 3. Compressive Strength of the Coated Particles

### 3-1. Producing the Resin Composition and the Injection Material

### Example 1P

First, a methyl p-toluenesulfonic acid (the acid-curing agent A: p-toluenesulfonic acid, the blocking compound: methanol; “PTSM”, MPTSA made by MRC UNITEC Co., Ltd.) was prepared as the acid-curing agent A whose acid group was blocked and the furan resin 1 was prepared as the acid-curing resin B. Further, the methyl p-toluenesulfonic acid and the furan resin 1 were mixed with each other so that the amount of the methyl p-toluenesulfonic acid became 5 parts by weight with respect to 100 parts by weight of the furan resin. As a result, a resin composition of example 1P was produced.

Next, potassium chloride aqueous solution of guar gum (55 g) was prepared as liquid (fluid). Then, a mixture preliminary prepared by stirring and mixing sand particles (50 g) having an average particle size of 250 μm and the resin composition was mixed into the liquid to produce an injection material.

In this regard, the contained amount of the resin composition was set so that the contained amount of the acid-curing resin B became 2.5 wt % with respect to the whole of the injection material.

### Example 2P

A resin composition and an injection material of example 2P were produced in the same manner as the example 1P except that the potassium chloride aqueous solution of the guar gum was used as the liquid (fluid).

### Example 3P

A resin composition and an injection material of example 3P were produced in the same manner as the example 1P except that an ethyl p-toluenesulfonic acid (the acid-curing agent A: p-toluenesulfonic acid, the blocking compound: ethanol; “PTSE”, EPTSA made by MRC UNITEC Co., Ltd.) was prepared as the acid-curing agent A whose acid group was blocked.

### Example 4P

A resin composition and an injection material of example 4P were produced in the same manner as the example 1P except that a hexyl p-toluenesulfonic acid (the acid-curing agent A: p-toluenesulfonic acid, the blocking compound: 1-hexanol; “hexyl p-toluenesulfonic acid”, HPTSA made by Tokyo Chemical Industry Co., Ltd.) was prepared as the acid-curing agent A whose acid group was blocked.

### Comparative Example 1P

A resin composition and an injection material of comparative example 1P were produced in the same manner as the example 1P except that a mixture of bisphenol A type epoxy resin (“828EL” made by Mitsubishi Chemical Corporation) and a curing agent (“TEPA” made by Tokyo Chemical Industry Co., Ltd.) was used as the resin composition.

In this regard, the contained amount of the curing agent in the resin composition was set to be 14 parts by weight with respect to 100 parts by weight of the epoxy resin.

### Comparative Example 2P

A resin composition and an injection material of comparative example 2P were produced in the same manner as the example 1P except that the potassium chloride aqueous solution of the guar gum was used as the liquid (fluid).

### 3-2. Evaluation for the Compressive Strength of a Cured Material Obtained from the Injection Material

The obtained injection material of each of the examples and the comparative examples was injected into a bottomed cylindrical body formed from an aluminum foil having a cylindrical shape and then heated in this state. After that, by removing the cylindrical body, a cured material having a diameter of about 50 mm and a height of about 20 mm was obtained.

In this regard, for the examples 1P and 2P and the comparative example 2P, heating conditions at the time of obtaining the cured material were set to the temperature of 60° C. and the time of 20 hours. For the example 3P, the heating conditions were set to the temperature of 80° C. and the time of 20 hours. For the example 4P, the heating conditions were set to the temperature of 100° C. and the time of 20 hours. With the above heating conditions, one cured material of each of the above examples and the comparative example was obtained. Further, for the comparative example 1P, the heating conditions were set to a combination of the temperature of 60° C. and the time of 20 hours, a combination of the temperature of 80° C. and the time of 20 hours and a combination of the temperature of 100° C. and the time of 20 hours. With the above combinations of the heating conditions, three cured material of the comparative example 1P were obtained. In the case of heating at the temperature of 60° C., a supernatant injection material was removed after 2 hours.

Then, as the compressive strength, a breaking force at the time of compressing each of the obtained cured materials under a condition that a head speed was 5 mm/min (measurement temperature: room temperature) was measured.

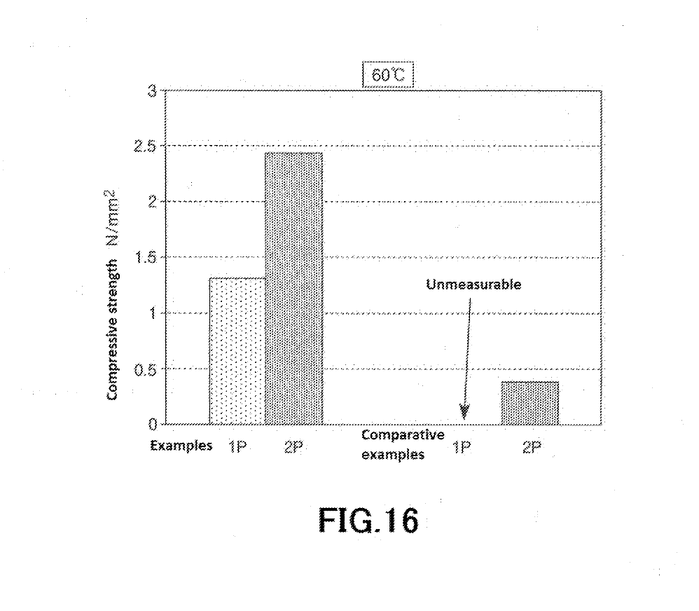

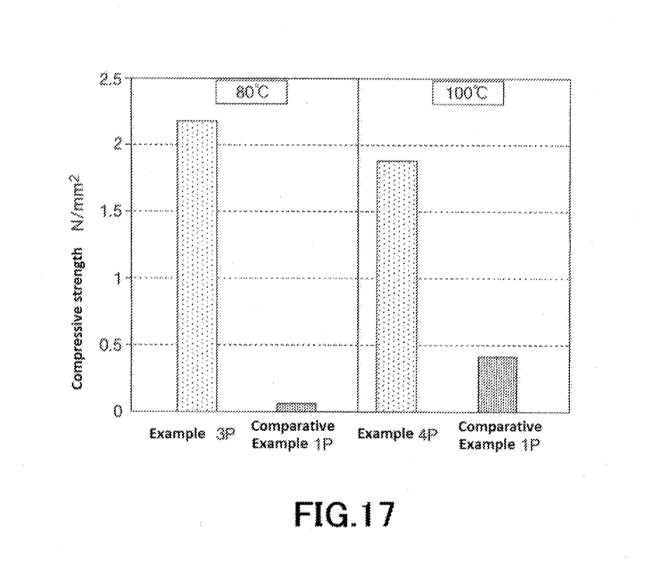

The obtained results are shown in FIGS. 16 and 17.

As shown in FIGS. 16 and 17, the cured material obtained from the injection material of each of the examples provides a superior compressive strength compared with the cured material obtained from the injection material of each of the comparative examples. It is considered that this result is caused from the fact that the acid-curing resin B in each example starts to cure in a state that the acid-curing resin B adheres (entwines) to the sand particles.

### INDUSTRIAL APPLICABILITY

The present invention relates to the resin composition used for forming the surface layer covering at least a part of the outer surface of the particle adapted to be packed into the fracture formed in the subterranean formation. The resin composition comprises the acid-curing agent and the acid-curing resin which can cure in the presence of the acid. The acid-curing agent has the acid group which is present in a state that the acid group is blocked by the compound having the reactivity with respect to the acid group. Further, the property of the resin composition is set so that the acid-curing resin starts to cure at the temperature in the range of 50 to 110° C. and within the time in the range of 2 to 8 hours by adjusting the kind and the amount of each of the acid-curing resin, the acid-curing agent and the compound. According to the present invention, it is possible to provide the resin composition which can reliably allow the acid-curing resin to cure at the target location, the injection material containing the resin composition and the particles, and the method for packing the particles into the fracture formed in the subterranean formation. For the reasons stated above, the present invention is industrially applicable.

### DESCRIPTION OF REFERENCE SINGS

1 Coated particle
2 Particle
3 Surface layer
A Acid-curing agent
B Acid-curing resin
Fluid
100 Injection material (resin composition)
91 Wellbore
92 Fracture
L Subterranean formation
P Pump
S Land surface

1. A resin composition used for forming a surface layer covering at least a part of an outer surface of a particle, the particle adapted to be packed into a fracture formed in a subterranean formation, the resin composition comprising:
an acid-curing agent; and
an acid-curing resin which can cure in the presence of an acid,
wherein the acid-curing agent has an acid group which is present in a state that the acid group is blocked by a compound having a reactivity with respect to the acid group, and
wherein a property of the resin composition is set so that the acid-curing resin starts to cure at a temperature in the range of 50 to 110° C. and within time in the range of 2 to 8 hours by adjusting a kind and a contained amount of each of the acid-curing resin, the acid-curing agent and the compound.

2. The resin composition as claimed in claim 1, wherein the property of the resin composition is set so that the acid-curing resin completes curing thereof within 48 hours.

3. The resin composition as claimed in claim 1, wherein the compound has a functional group, and
wherein the functional group chemically bonds with the acid group of the acid-curing agent to block the acid-curing agent.

4. The resin composition as claimed in claim 3, wherein the functional group contains at least one selected from the group consisting of a hydroxyl group and an amino group.

5. The resin composition as claimed in claim 1, wherein the compound is an alkyl alcohol having a hydroxyl group as the functional group.

6. The resin composition as claimed in claim 5, wherein the alkyl alcohol is a monohydric alkyl alcohol.

7. The resin composition as claimed in claim 6, wherein a carbon number of the monohydric alkyl alcohol is in the range of 1 to 10.

8. The resin composition as claimed in claim 1, wherein the compound is an alkyl amine having an amino group as the functional group.

9. The resin composition as claimed in claim 3, wherein when the number of the acid groups is defined as “1”, the compound contains the functional groups so that the number of the functional groups satisfies a relationship of the number of the acid groups:the number of the functional groups=1:0.1 to 1:1.9.

10. The resin composition as claimed in claim 1, wherein the acid group contains a sulfonic acid group.

11. The resin composition as claimed in claim 10, wherein the acid-curing agent contains at least one selected from the group consisting of a p-toluenesulfonic acid, a benzenesulfonic acid, a dodecylbenzenesulfonic acid, a phenolsulfonic acid, a naphthalene sulfonic acid, a dinonylnaphthalene sulfonic acid and a dinonylnaphthalene disulfonic acid.

12. The resin composition as claimed in claim 1, wherein the contained amount of the acid-curing agent is in the range of 0.25 to 20 parts by weight with respect to 100 parts by weight of the acid-curing resin.

13. The resin composition as claimed in claim 1, wherein the acid-curing resin contains at least one selected from the group consisting of a furan resin and a phenol resin.

14. A resin composition used for forming a surface layer covering at least a part of an outer surface of a particle, the particle adapted to be packed into a fracture formed in a subterranean formation, the resin composition comprising:
a para-toluenesulfonic acid serving as an acid-curing agent; and
a furan resin serving as an acid-curing resin which can cure in the presence of an acid,
wherein the para-toluenesulfonic acid has a sulfonic acid group which is present in a state that the sulfonic acid group is blocked by a monohydric alkyl alcohol having a carbon number in the range of 1 to 6 and serving as a compound having a reactivity with respect to the sulfonic acid group, and
wherein a property of the resin composition is set so that the furan resin starts to cure at a temperature in the range of 70 to 90° C. and within time in the range of 4 to 6 hours by adjusting a contained amount of the para-toluenesulfonic acid, which is blocked by the monohydric alkyl alcohol, with respect to 100 parts by weight of the furan resin to fall within the range of 0.25 to 20 parts by weight.

15. An injection material adapted to be injected into a fracture formed in a subterranean formation, the injection material comprising:
particles to be packed into the fracture;
the resin composition defined by claim 1; and
a fluid for transferring the particles and the resin composition into the fracture.

16. The injection material as claimed in claim 15, wherein an average particle size of the particles is in the range of 100 to 3,000 μm.

17. The injection material as claimed in claim 15, wherein a contained amount of the particles is in the range of 5 to 50 wt %.

18. The injection material as claimed in claim 15, wherein a contained amount of the resin composition is in the range of 1 to 20 parts by weight with respect to 100 parts by weight of the particles.

19. A packing method for packing particles into a fracture formed into a subterranean formation by transferring the injection material defined by claim 15 into the fracture formed in the subterranean formation through a wellbore penetrating the subterranean formation to inject the injection material into the fracture, the packing method comprising:
reacting an acid-curing agent with an acid-curing resin by allowing a compound to leave from the acid-curing agent by using a subterranean temperature and/or pressure at the time of injecting the injection material into the fracture to cure the acid-curing resin due to an action of the acid-curing agent and cover at least a part of an outer surface of each of the particles with a cured material of the acid-curing resin.
